(19) United States
(12) Patent Application Publication
(10) Pub. No.: US 2012/0209673 A1
(43) Pub. Date: Aug. 16, 2012

(54) System and Method for Merchant's Benefit-focused Electronic Coupon Distribution Business

(76) Inventor: Kyung Jin Park, Fort Lee, NJ (US)

(21) Appl. No.: 13/368,042

(22) Filed: Feb. 7, 2012

Related U.S. Application Data
(60) Provisional application No. 61/463,197, filed on Feb. 14, 2011.

(51) Int. Cl. G06Q 30/02

(52) U.S. Cl. 705/14.15

(57) ABSTRACT

The present invention relates to a system and method for merchant's benefit-focused electronic coupon distribution business. The invention provides an online platform connecting merchants to targeted consumers without sales people. The online platform provides merchants with profile pages where the merchants can manage and sell coupon offerings. Consumers can search and purchase one-time use coupons based on the coupon offerings. Each one-time use coupon carries unique identification number and code, and the coupon is tracked to provide information back to registered merchants. This invention minimizes the risk and marketing promotion cost by shifting the burden of marketing cost to the consumers' side. Instead of paving for marketing costs upfront, merchants receive micropayments from consumers through coupon offerings and selling one-time use coupons. This invention creates a get-paid-to-participate-marketing for merchants, and ways to access more discounts from more local businesses for consumers.

### CROSS-REFERENCES TO RELATED APPLICATION

The present non-provisional patent application claims the benefit of priority under 35 U.S.C. §119 from U.S. Provisional Patent Application Ser. No. 61/463,197 entitled “Merchant-focused e-coupon business model,” filed on Feb. 14, 2011, the disclosure of which is hereby incorporated by reference in its entirety for all purposes.

### BACKGROUND OF THE INVENTION

1. Field of the Invention

The present invention is related in general to electronic coupon business model, and more particularly to the system and method of doing electronic coupon distribution business which provides an online platform, such as a website, for merchants to upload and manage their coupon offerings by themselves for free and without intervention from a website provider, and consumers pay a small amount to obtain one time use coupons according to the same terms and conditions described by the merchant's coupon offerings, upon searching through their desired local markets. This invention also provides merchants with their coupon sales revenue minus sales commission to the website provider as well as with consumer data, coupon data, and market data, including merchant data, which makes the invention a get-paid-to-participate-marketing for businesses. In this invention, consumers are responsible for the cost of the marketing of the businesses by paying small amounts of fees, whereas tradition coupon business models require businesses to pay for the cost of marketing for promoting his/her businesses.

2. Description of the Prior Art

Typically, businesses, merchants, retailers (hereinafter “merchants”) offer consumers with coupons as an incentive which provides the consumers with discounts, or form of other rewards, for shopping and purchasing their particular products, goods, and/or services provided by the merchants. This helps to drive new foot traffic into the store as well as build business reputations. The coupons have been distributed to the consumers in paper format and/or electronic format.

In the traditional coupon business model, merchants pay coupon service provider(s) (hereinafter “CSP”), including online or offline CSP's, with upfront costs to distribute coupons to promote their businesses, products, goods, and/or services. Although these merchants spend a lot of upfront costs to design, make, and distribute the coupons to the consumers, whether through traditional U.S. Postal Mailing services or online through the CSPs' websites, the merchants cannot estimate how many coupons will actually be redeemed, track how many customers will indeed visit their stores, purchase their products, goods or services using those coupons, and/or ultimately learn if the coupon marketing was effective or not.

In the newer coupon business model, CSP's have integrated group-buying ideas into its current discount business model, which eliminates the upfront cost for the merchants. In this new type of coupon business model, instead of distributing discount coupons (X % off, or $Y off of $Z purchases) to the consumers, the coupon service providers sell vouchers instead, which works as similar to gift cards, in order to generate profits and make consumers to dedicate to their purchases. However, in order to promote group-buying marketing, the merchants are needed to take a big risk by offering huge discounts, as well as untrained merchants to accept large number of consumers in a short period of time. This led to many merchants losing huge capital for participating in coupon promotions which they are not familiar with, as well as a loss of trust from many local consumers who had to deal with large number of crowds every time they visited those merchants' business locations. Even for the consumer side, the consumers are also forced to pay a large sum of cash upfront for the products, goods, and/or services for something they are not sure of purchasing.

In both of the above coupon business models mentioned, traditional and the group-buying models, generally most of the coupon service providers, including the online and offline coupon service providers, receive certain fee from the merchants for advertising and distributing coupons or e-coupons to the consumers. Some online coupon service providers do sell e-coupons on behalf of the merchants to the consumers, however, does not share any of the coupon sales proceed with the merchant or share data with the merchants needed for the merchants' future growth.

These coupon business models provided by the current coupon service providers, including the online or offline coupon service providers, is only focused on the benefits of the coupon service providers themselves and/or the consumers, rather than the benefit of merchants, who are the key ingredients in such coupon industries. Thus the small merchant and businesses who have limited marketing budgets cannot afford to participate in promoting their businesses under such current traditional coupon and e-coupon business models.

These coupon service providers also do not provide merchants with information of the consumers who have purchased and used the coupons of the merchants, information of market where the competitors of the merchants are located near the business place of the merchants, and/or information of each of the coupons which is purchased, unused, redeemed and/or returned (refunded). These are critical information for the merchants who invest capital in order to promote their products, goods and/or services. Additionally, the coupon service providers do not provide merchants with tools and services which merchants themselves can create, manage, and control their own coupons offering terms in real-time. This is needed in order for businesses to react quicker in the case the coupons offered are not effective or even may hurt their businesses.

Therefore, there is a need for a system and a method of doing a coupon business distribution system, specifically online-to-offline electronic coupon in the industry, with a business model that's focused on the benefits of merchants first, but not detrimental to the consumers and the coupon service providers. The online side of the business model can track, manage, and help businesses with customer and market information by providing the data back to the merchant, while the offline side of the business model can help consumers enjoy the discounts on products, goods, and/or services locally.

Such merchant-focused online-to-offline, or e-coupon business model, will 1) provide an online platform, such as a website, for merchants to upload and manage their coupon offerings by themselves for free and without intervention from the website provider or the coupon service provider and sell one time use coupons based on the same terms and conditions of the coupon offerings which the merchants have created, 2) for consumers can take advantage of the coupon offerings by buying one time use coupon based on the same terms and conditions of the coupon offerings upon searching through their desired local markets, 3) create and provide merchants with profile webpage for free by displaying the merchant information and their coupon offering information on the profile webpage to consumers to review and buy coupons of the merchants, 4) provide merchants with their coupon sales revenue minus sales commission to the website provider or the coupon service provider in order to regain some of the losses from coupon offerings, and 5) provide merchants with more marketing options as well as consumer data, coupon data, and market data including the merchant and competitor data, so that the merchants can effectively make a future business decisions.

This type of business model is the first in its kind where consumers would pay for the marketing and promoting of the businesses, whereas until now, merchants were solely responsible for the cost of the marketing and promoting of their businesses. Consumers still take advantages of discounts given by the merchants, and the coupon service providers can still benefit by collecting local market consumer data as well as commissions from the coupon sales revenue.

### SUMMARY OF THE INVENTION

The present invention is related to the system and method for merchant's benefit-focused electronic coupon distribution business in the online-to-offline market, where it allows merchants and consumers to use online system to search and manage coupons, and integrate the experiences in the offline/local world. The invention provides an online platform, such as a website, for merchants to upload and manage their coupons offerings by themselves for free and without intervention from the website provider, and to sell one time use coupons based on the coupon offerings which the merchants have created and, for consumers to buy those one time use coupons that merchants created upon searching through their desired local markets. The coupon offering itself does not have any values or be used to get discounts from the merchant, however, upon consumers paying a small fee, the consumer can receive a one time use coupon under the same terms and condition set by the merchant in their coupon offerings.

The process scheme of the invention is described as follows: 1) merchants register accounts with the CSP's online website in self-serve, self-manage format, which during the registration process, the merchant makes coupon offerings with the terms and conditions fit into their specific businesses which minimizes the risks, 2) while the coupon offering itself does not act as a discount voucher at the merchants' business locations, consumers then purchase a one time use coupon by searching, choosing the coupon offering, make a small payment, which then the consumers receive one time use coupon with a unique coupon code, 3) consumers take the one time use coupon with an unique coupon code to the merchant, 4) merchants receive, validate, and redeem one time use coupon and gives proper discount to the consumer according to the terms and conditions created during the coupon offering creation process, 5) CSP analyzes the one time coupons purchased, redeemed which are used to create a report, and provide said report back to the merchants along with a type of payment form which was paid by the consumer, minus the sales commission by the CSP, which is not more than a half of the merchants' one time use coupon sales revenue.

One embodiment of a system for merchant-focused electronic coupon business is comprised of Merchant Database, Merchant ID/Client Table, Merchant Webpage Server Engine, Coupon Database, Coupon Order Database, Coupon Generator Engine, Coupon Validation Engine/Automated Phone Service Center, Market Database, Market Database Analysis Engine, Consumer Database, and Consumer ID/Client Table.

Merchant Database stores merchant information which receives merchant information during the Merchant Account registration process. It is connected to Merchant Webpage Server Engine, which offers merchants with user interface to register merchant's business information as well as creation of coupon offering with terms and conditions which would fit the specific merchant's needs. Coupon Database stores the merchant coupon offering terms.

Merchant ID/Client Table (MICT) sorts merchant information and coupon offering terms information from Merchant Database and Coupon Database, one time use coupons information from Coupon Order Database (COD) including the coupon offering terms, price and the status of each of one time use coupons purchased by consumers, and coupon sales information from the COD. The MICT provides merchants with their coupon sales revenue minus sales commission through MICT wherein said sales commission is not more than a half of the merchants' coupon sales revenue.

Merchant Webpage Server Engine (MWSE) runs the CSP website by retrieving merchant and coupon information through Merchant ID/Client Table, and provides the merchants and consumers with merchants' profile webpage by displaying the list of merchants and coupon offering information for consumers to review the coupon offerings from the merchants. Consumers are also able to purchase one time use coupons through the MWSE. Coupon Database provides the merchants with coupon guidelines including a list of coupon terms and a range of coupon price which the merchants can select, and also stores and maintains the terms and condition, and other information of the coupon offerings created by the merchants under the coupon guidelines provided by CSP. Coupon Order Database (COD) includes information of one time use coupons which have been purchased by the consumers, as well as used and redeemed, unused and not redeemed, exchanged, and refunded, and expired one time use coupons. the COD further includes information of the coupon offering terms, price and the status of each of one time use coupons purchased by consumers as well as other coupon sales information which then is analyzed to provides merchants with their coupon sales revenue minus sales commission through MICT. The COD database is connected to Consumer ID/Client Table (CICT) and MICT to connect information from consumers to merchants. The COD will be used to provide merchants with the merchants' customer information.

Coupon Generator Engine (CGE) retrieves available coupon terms and information from the Coupon Database to verify the coupon offering terms, and create a one time use coupon with an unique coupon identification number which it stores in COD upon consumers' purchase of a coupon from merchant's coupon offerings.

When Coupon Validation Engine (CVE) receives information of the one time use coupon which the consumers purchased, it checks through COD to see if the coupon is valid, after the merchant scans or redeems the coupon code to validate during a one time use coupon redemption process. Automated Phone Service Center (APSC) is integrated within this CVE and resolves problems between the merchants and the consumers related to the coupons if the problems arise at the business locations of the merchants, before, during or after shopping at the store. Market Database automatically retrieves the information from the Merchant Database and Coupon Database, as well as accept and store manually inputted information added by CSP, such as U.S. Census Data, almanac data, and/or other free or paid government data or statistics.

Market Database Analysis Engine (MDAE) runs to provide the merchants with local market data in an understandable format by using the information collected in Market Database, Coupon Database, Merchant Database and Consumer Database, and also provides the merchants with advanced marketing options. The Consumer Database is connected with Merchant Webpage Server Engine through Consumer ID/Client Table (CICT) to provide consumers with user interfaces including a main webpage and consumer account, as well as retrieves consumer information during the Consumer Account registration process. Consumer ID/Client Table (CICT) sorts the consumer information from Consumer Database and Coupon Order Database (COD) which stores all of the purchased one time use coupon information purchased by the consumers.

While the invention is made with the focus of the merchants' benefit first, invention also provides simple access to the service for consumers, and includes the scheme as follows: 1) a graphical user interface as a main webpage that allows consumers to use in the process of searching and buying available merchants and coupon offerings, and to register or log-in to consumer account, and this allows consumers to review the merchants and buy one time use coupons based on the coupon offerings, 2) allow consumer to input consumers' basic and optional personal information into the consumer account, search desired markets by inputting search terms and location, or by browsing through map application, and manage the consumers' used or unused one time use coupons and print said coupons, wherein the consumer account includes personal information management tab, available coupon tab, used/expired coupon tab, and buy coupon tab.

For merchant, the invention provides 1) a graphical user interface which a merchant can log-in or register for a new merchant account, which requires a input by the merchant of the financial account information and the merchant's basic and advanced business information into the merchant account, as well as inputs the merchant's coupon offering terms and the prices of how much each coupon offerings shall sell for, as well as manage and control the merchant's financial account and business information and the merchant's coupons terms and prices, and also have an optional link to the merchant's own social networking accounts, wherein the merchant account includes coupon management tab, business information tab, advanced marketing tools tab, and market data analysis tools tab, 2) the merchant who has registered for a merchant account, allowing consumers to view the merchant profile webpage as well as the coupon offerings, will be given an option to review the market information at free of charge, sold coupon information, the merchant's customer information which the coupons are sold to, as well as the merchant's similar industries' coupon offerings information, 5) merchant with coupon guidelines, including a list of coupon terms and conditions which the merchant can select from for his or her own coupon offerings and a range of coupon prices within which the merchant by himself or herself can put a fixed price for their own coupons for sale to the consumers

Once a coupon offering from a merchant is searched, chosen and paid by a consumer, this invention creates a one time use coupon with an unique coupon identification number and code so that the merchant can track each of the coupons and learn of the information of the coupon purchased as well as of the consumers who purchased it, including how many coupons were purchased, unused, redeemed, returned, expired, who purchased each of the coupons, as well as how long it took to redeem the coupons, providing the merchant with their own customer patterns.

The invention also provides the merchant with the merchant's coupons sales revenue, after deduction of the sales commission, wherein the sales commission is not more than a half of the coupon sales revenue of the merchant, thus making consumers the final responsible holder for the cost of the marketing of the merchant's businesses.

The invention further provides the merchant with advanced marketing options through Advanced Marketing Tools, which at this time, the merchant is also responsible for the cost of the marketing to provide more targeted promotions to the consumers, along with a more detailed analysis of the coupon data, customer data, and market data through the market data analysis tools of the merchant accounts. Advanced Marketing Tools option comprises a featured list tool, a hot list tool, a newsletter tool, a local merchant advertisement tool, a daily deal offer tool, a daily coupon offer tool, and a weekly special tool. The merchants, through Advanced Marketing Tools option, can effectively promote their business in order to increase of sales of products, goods and/or services through coupon offerings for either general or specific products, goods and/or services, which can be an effective tool to lower non-moving stocked inventories. The market data includes local data and nationwide data related to the merchant's business and industry categorized by the merchants, and the market data is provided to the merchants in either narrative form, chart form, and/or graphic form.

### BRIEF DESCRIPTION OF THE DRAWINGS

FIG. 1 is one embodiment of a block diagram of system components of the Coupon Service Provider (CSP).

FIG. 2 illustrates an example of a user interface as Main webpage that may be presented to consumers to allow coupon search, and a link to go to merchant account page.

FIG. 3 illustrates an example of a user interface as Merchant List upon consumer's search.

FIG. 4 illustrates an example of a user interface as Merchant Profile webpage that allows consumers to look at the detailed information of the merchant and the list of its coupons.

FIG. 5 illustrates an example of a user interface as Coupon Information webpage that allows consumers to check the information of the selected coupon.

FIG. 6 illustrates an example of a user interface as Coupon Purchase webpage which allows consumers to check the coupons terms, review the price of the coupons in the shopping cart and to select the method of payment when purchasing the coupons.

FIG. 7 is a flow diagram illustrating the process of Merchant Account registration.

FIG. 8 is an exemplary screen display of a coupon, of which terms are created by a merchant and unique coupon code and number are generated by Coupon Generator Engine after purchased by a consumer.

FIG. 9 is a flow diagram illustrating a process of managing the Merchant Account.

FIG. 10 is a flow diagram illustrating a process of registering for Consumer Account.

FIG. 11 is a flow diagram illustrating a process of managing the Consumer Account.

FIG. 12 illustrates an example of user interface that allows consumers to choose one of coupon delivery methods.

FIG. 13 is a flow diagram illustrating a process of purchasing coupons.

FIG. 14 is a flow diagram illustrating a process of coupon with its identification number by Coupon Generator Engine (CGE).

FIG. 15 is a flow diagram illustrating a process of redeeming coupon by a merchant.

FIG. 16 illustrates an example of a user interface as Advanced Marketing Tools webpage.

FIG. 17 illustrates an example of a user interface as Featured List Tool webpage that allow merchants to choose feature period, regions, and coupons for advertising.

FIG. 18 illustrates an example of a user interface as Daily Coupon Offer Tool webpage that allow merchants to choose desired feature period and regions and to create coupon for daily coupon offer.

FIG. 19 illustrates an example of coupon data for merchants in dry cleaner industry.

FIG. 20 illustrates an example of consumer data for merchants in dry cleaner industry in the form of a pie chart.

FIGS. 21 A-B illustrate examples of graphic charts of market data for merchants in dry cleaner industry.

### DETAILED DESCRIPTION OF THE INVENTION

As used herein, the term “merchant” refers to any person, business enterprise or other entity that desires to provide others, commonly considered consumer(s), with goods, products, and/or services, while “consumer” refers to any person, business enterprise or other entity that desires to obtain goods, products, and/or services from others, commonly considered merchant(s).

The definition of coupon offering, hereinafter, describes the terms and condition, and prices of the coupons being sold to consumers, and one time use coupon, hereinafter, describes the coupons purchased by the consumers to be able to redeem at the merchants' business location(s), which as the same terms and conditions are transferred from the coupon offerings, in which the merchants have created and decided.

Nowadays in most marketing promotions available to the merchants, the merchants are solely responsible for the marketing cost of their business promotions, especially in the coupon marketing industries. In addition, merchants are to forced decrease profit margin level, sometime even up to unwanted or undesired level, by giving large discounts via coupons to consumers. Some form of coupon marketing only charges merchants for those coupons and vouchers that are redeemed, such as in the case of a group-buying discount marketing, and some form of coupon marketing are offered free to the businesses and consumers, however, none of these marketing actually protects merchants from the risks by holding responsible for contract terms between coupon service provider and merchant, sometimes upfront cost, or able to provide any information back to the merchants.

Especially in the traditional coupon businesses models, where the merchants mail out the coupons to local residents via traditional mailing services, merchants cannot help but to take a big risk by designing and creating the coupons, in addition to a fee which the merchants must pay to distribute the coupons via U.S. Postal Mail, as well as unable to expect or estimate how many coupons are kept in the hands of the consumers, how many are waiting to be redeemed, how many will actually be redeemed, or changing the terms of the distributed coupons upon finding an error inside the coupon's terms and conditions.

Although the newer e-coupon business models have reinforced some of the disadvantages of the traditional coupon business models, such as adding search features or saving costs on the creation of the coupons or mailing the coupons, there still remains many disadvantages which includes unable to track how many coupons are printed or to be redeemed, as well as collection of the data which should be able to be shared with the merchants.

The present invention gets rid of all the risk said above by letting the merchants to expect how many consumers will walk in with the coupons, control terms of the coupons at any time in a case an error has been found, collect and share consumer data with the merchant, all while paying the merchant to participate in such marketing services. Through the invention, coupon is not just a marketing tool to increase traffic for merchants anymore, but also a tool to learn more about their customers and to plan for the unknown business future. As for consumers, can be a part of usual daily activity, a new concept and a way to connect and find out about the local shops and businesses, while receiving discounts from more local merchants.

The present invention is focused on the benefits of merchants before any other party. The embodiment of the invention comprises three parties: merchant(s), consumer(s), and a Coupon Service Provider (CSP), such as a website server for merchant-focused electronic coupon marketing. The CSP provides an online platform for merchants and retailers to upload and manage coupons offerings by themselves for free and without any intervention from the CSP and sell one time use coupons to the consumers. Upon consumers searching through their desired local markets, the CSP provides a platform where it allows the consumers to buy one time use coupons from the merchants who registered, based on the same terms and conditions of the merchants' coupon offerings made by the said merchants.

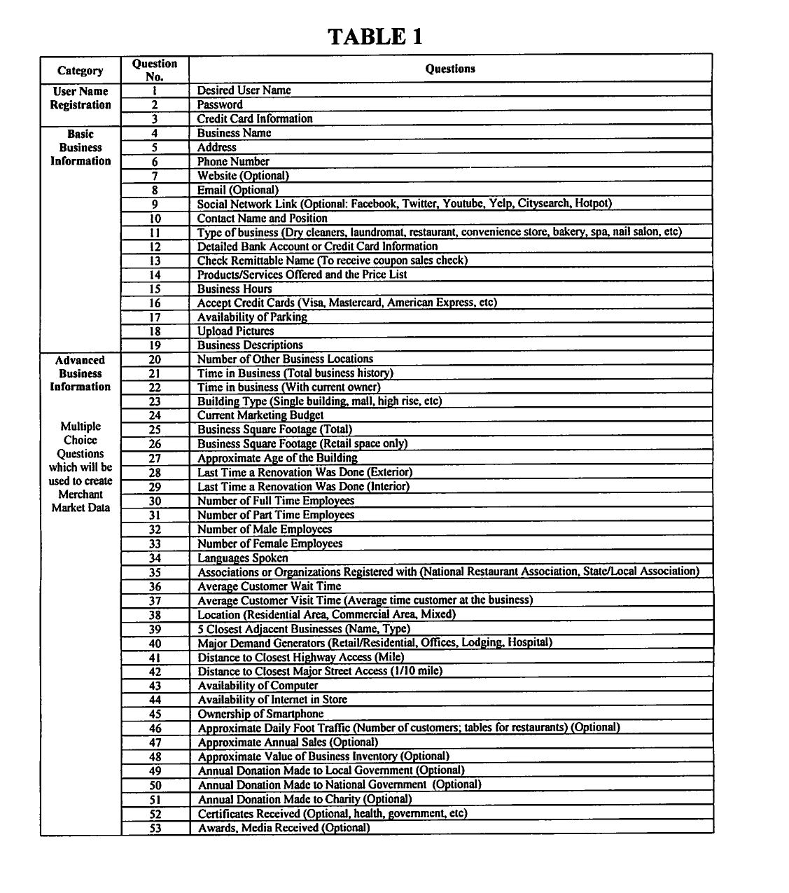

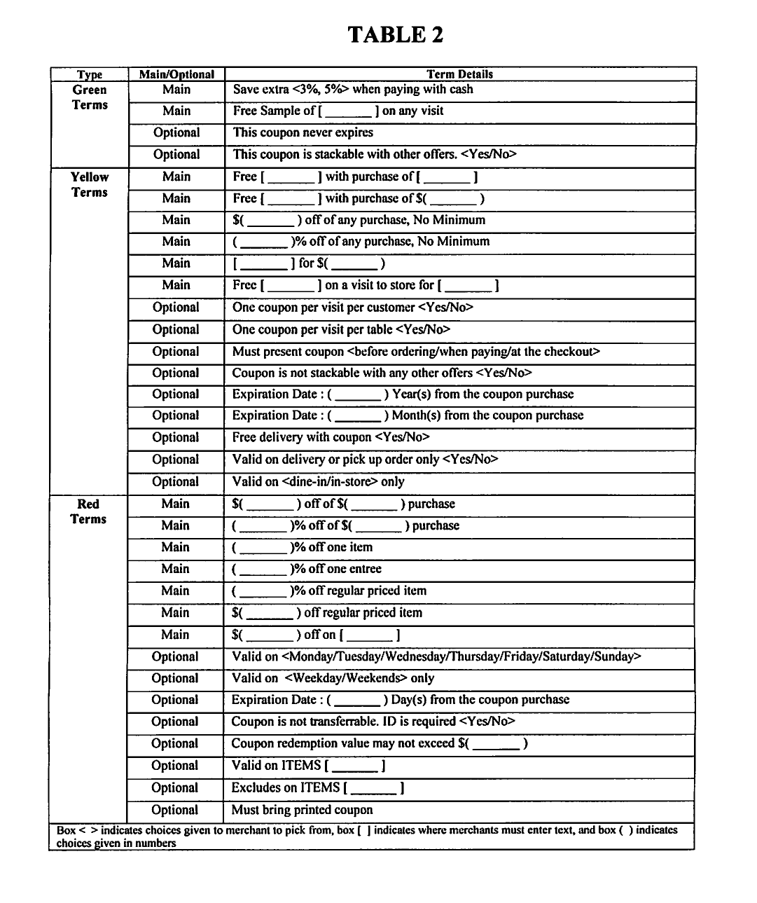

FIG. 1 is one embodiment of a block diagram of system components of the Coupon Service Provider (CSP). Referring to FIG. 1, one embodiment of a system of the CSP comprises Merchant Database, Merchant ID/Client Table, Merchant Webpage Server Engine, Coupon Database, Coupon Order Database, Coupon Generator Engine, Coupon Validation Engine/Automated Phone Service Center, Market Database, Market Database Analysis Engine, Consumer Database, and Consumer ID/Client Table.

Through Merchant Webpage Server Engine, Merchant Database provides merchants with graphical user interface as the database retrieves merchant information during a Merchant Account registration process. Merchant ID/Client Table (MICT) sorts merchant information from Merchant Database, coupon offering information from the merchant's Coupon Database, one time use coupons information from Coupon Order Database (COD) including the terms, prices, status of each of one time use coupons that consumers have purchased, and one time use coupon sales information from COD. The MICT, through the one time use coupon sales information, provides the merchants with their coupon sales revenue minus sales commission, wherein said sales commission is not more than a half of the merchants' coupon sales revenue, along with reports on one time use coupon sales. By providing the merchant with the sales revenue generated from coupon sales to the consumers, the invention is the first promotion business model to provide get-paid-to-participate-in-marketing program.

Merchant Webpage Server Engine runs the CSP website by retrieving merchant and coupon information through Merchant ID/Client Table, and provides the merchants with their profile webpage by displaying merchant and coupon information, which the consumers are able to review and buy coupons of the merchants. Coupon Database provides the merchants with coupon offering creation guidelines including a list of coupon terms and a range of coupon price which the merchants can select, and also stores and maintains the terms and information of the coupons created by the merchants under the coupon guidelines. Coupon Order Database (COD) includes information of the one time use coupons which have been purchased, used and redeemed, unused and not redeemed, exchanged, and refunded, and which expired. The COD further includes information of the coupon offering terms, price and the status of each of one time use coupons purchased by consumers as well as other coupon sales information which then is analyzed to provides merchants with their coupon sales revenue minus sales commission through MICT. The COD is connected to Consumer ID/Client Table (CICT) and MICT to connect information from the consumers to the merchants. The COD will be used to provide merchants with the merchants' customer information through MICT. Coupon Generator Engine (CGE) retrieves available coupon terms and information from Coupon Database to verify the coupon, and create a one time use coupon with a unique coupon identification number which it gets stored in COD when consumers purchase the coupon. Coupon Validation Engine (CVE) receives information of the one time use coupon being redeemed by the merchants, in which consumers purchased, and then checks through COD to see if the coupon is valid and unused, during the coupon redemption process. Automated Phone Service Center (APSC) is integrated within this CVE and resolves problems between the merchants and the consumers related to the one time use coupons being redeemed, in the case problems arise at the location of the merchants', before, during or after shopping. Market Database includes and sorts the information of Merchant Database and Coupon Database, as well as accept, store, and sort manual information inputted by CSP, such as U.S. Census Data, almanac data, and/or other free or paid government data or statistics. Market Database Analysis Engine (MDAE) runs to provide the merchants with local market data in understandable format by using the information collected in the Market Database, Coupon Database, Merchant Database and Consumer Database, and is also used to provide the merchants with advanced marketing options. The Consumer Database provides consumers with graphical user interfaces through the Merchant Webpage Server Engine, including a main webpage through which consumers can search merchants and coupon offerings, consumer account managements, and also retrieves new consumer information during Consumer Account registration process. Consumer ID/Client Table (CICT) sorts the consumer information from Consumer Database and the information of one time use coupon purchased by the consumers in the Coupon Order Database (COD).

The invention helps merchants to create coupons offerings with terms and conditions, in which the merchants can decide the terms, the price of the coupons which the consumers will pay to get one time use coupons, which meet their business type, location, range of discounts levels that fits into their margin level, and sell those one time use coupons online through the website of the CSP, by themselves without an intervention from the CSP. The website of the CSP, which is designed for consumers to search for local shops and coupon offerings, consumers can purchase one time use coupons according to the terms and price set by the merchant, and redeem them at the merchants' business locations. According to the invention, merchants can find out about who shops at their business location(s) because the CSP offers consumer data of those who have purchased coupons, back to the merchants. At the same time the coupons guarantee that the consumers will make a visit to the business location(s) at least once since those coupons were purchased by the consumers.

The brief process of merchant-focused e-coupon business model is performed as follows:
a) a merchant registers for Merchant Account on the website of the CSP, puts its financial information and business information into the account during the registration process, and also adds coupon offerings' price, terms and conditions, such as how much the discounts would be, the expiration dates, and/or the locations where it can be redeemed. During this process, the merchants can upload other business information, such as a menu, business pictures, business contact information and so on;
b) the merchant creates its own coupon offerings on the website without any fee within the CSP's guidelines;
c) the CSP automatically or manually approves the merchant's information;
d) the CSP automatically creates a merchant profile page on the CSP website for the merchant based on the information inputted during the registration process, including the coupon offerings;
e) the merchant manages its own coupon offerings and business information on the merchant's account webpage and/or on the profile page;
f) the CSP posts the coupon offerings on the CSP website on sale for consumers to purchase one time use coupons;
g) a consumer searches for and once chooses the type of coupon offerings they need, the consumer pays and receives a one time use coupon with a unique coupon number and/or code from the CSP website, either upon registration of a Consumer Account or not;
h) the one time use coupon has the same terms and condition described in the coupon offerings which the merchant has created, which includes, but not limited to, discount level, minimum purchase requirements, expiration date, and/or available redemption location;
i) the cost of coupon offering for sale is decided solely on merchant's discretion, and the amount paid is the cost of receiving a one time use coupon, which can be redeemed at merchants' business locations;
j) the consumer prints the coupon via a printer or other electronic device;
k) the consumer redeems the coupon at the merchant's location which meets the coupon offerings' terms and conditions;
l) the merchant checks the coupon with electronic device, with proper software or application;
m) the CSP checks validity of the coupon on its server;
n) the CSP approves the coupon;
o) the merchant gives discount to the consumer;
p) the CSP gives coupon sales revenue minus the commissions to the merchant; and
q) the CSP provides the merchant with report of the consumers, as well as other advanced marketing options and market data including customer data, coupon data, and merchant data, collected during the process of merchant account registration, consumer account registration, and consumer purchasing and redemption of the one time use coupons.

The present invention includes a website's user interface which is simple enough for anyone to understand at the first glance and easy for anyone to use in order to minimize the learning curve for both merchants and consumers. The website's user interface is divided into two groups: Merchant Account view and Consumer Account view. Two accounts are colored in two different color tones to ensure that merchants do not get confused with Consumer Account, and consumer to get confused with Merchant Account.

In the Consumer Account view, consumers can search desired markets, businesses, and products or services by inputting search terms or by browsing through map application, such as a Google Map API method. Once the consumers create and log-in to their account, the consumers can manage their used and/or unused one time use coupons and print them while on the website. Used coupons will have detailed information of when it was used, and the new and unused one time use coupons will have links to the merchants, their reviews, and options to print the purchased one time use coupons.

In the Merchant Account view, merchants can control their coupons terms, coupon prices as well as all of their business information. Merchants can also access (i) advanced marketing tools, which not only provides them with more marketing options, but also help them to effectively communicate with their existing or potential customers, and (ii) their market information including their coupon sales, used and unused one time use coupons sold to consumers, their customer information as well as their competitors information within the same or similar industries.

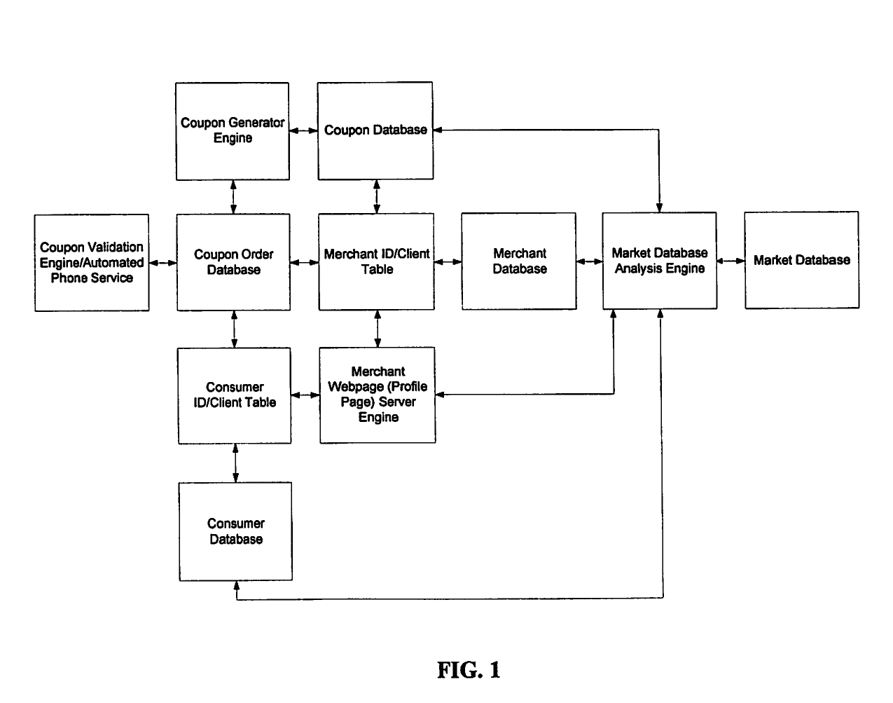

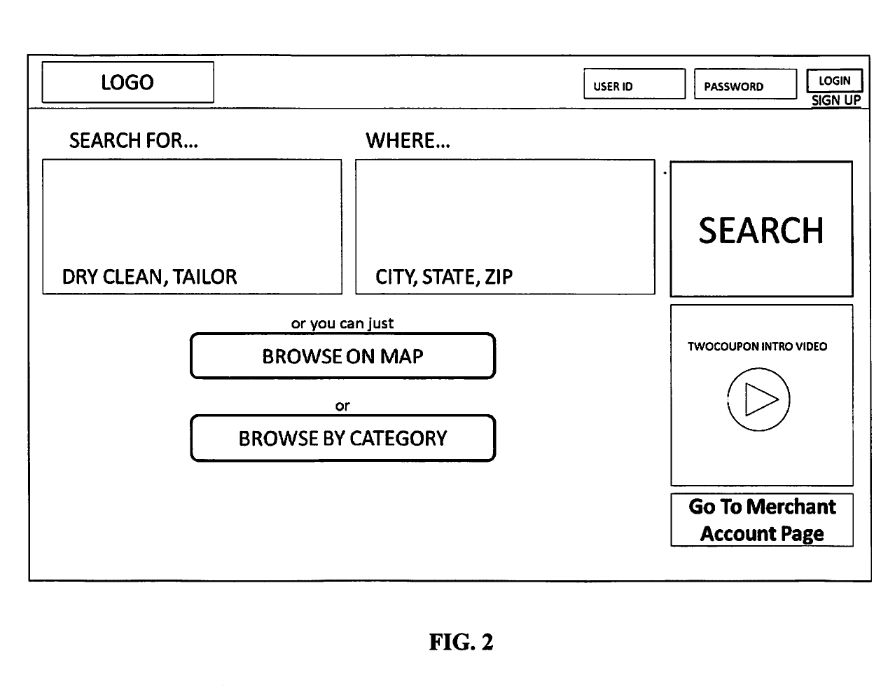

FIG. 2 through FIG. 6 illustrate exemplary user interfaces that allow customers to use in the process of searching and buying coupons. The CSP initially provides Main webpage described in the said Consumer Account view, on the website of the CSP. FIG. 2 illustrates an example of a user interface as Main webpage that may be presented to consumers to allow coupon search, Consumer Account log-in or registration, and to allow merchants to go to Merchant webpage described in the said Merchant Account view. The Main webpage includes Search Term (types of merchants, industries, products, services, and/or merchants' names) box, Location (City, State, Zip code) box, Browse on Map button, Browse by Category, Coupon Search button, Consumer Account log-in link, Consumer Account sign-up (registration) link, and an Go To Merchant Account link for merchants to go directly to the Merchant webpage are also listed on the Main webpage. Additionally, the Main webpage includes the introduction video of the CSP for consumers to know how to search and buy coupon(s) and what benefits consumers will have from the invention.

Consumers have three options on the Main webpage to search for merchants and their coupons and to purchase available the coupons, which can be done with or without registering for a Consumer Account.

One way to search for coupons is to enter search terms including the types of merchant information, products, services, and/or the location. Once the consumers inputs the types of merchants (businesses) which the consumers are looking for and the location where the consumers want to shop on the Main webpage, Merchant List webpage, as shown on FIG. 3, will be displayed to the consumers. FIG. 3 illustrates an example of a user interface as a Merchant List. The Merchant List webpage displays the list of the merchants and available coupon offerings along with the locations of merchants on a map, such as integrated Google Map API. The consumers can then choose a particular merchant from the listed merchants.

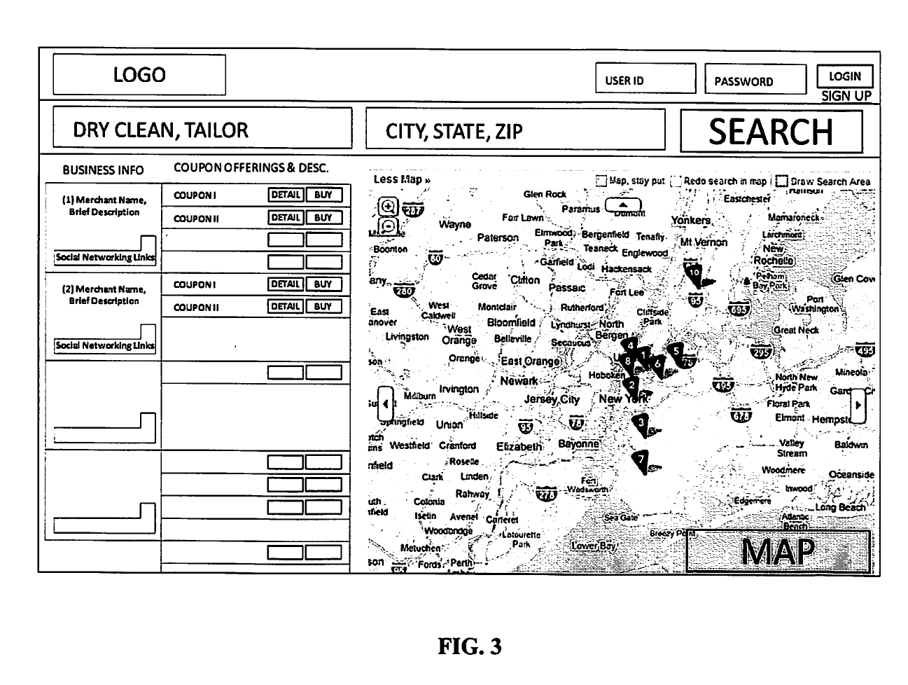

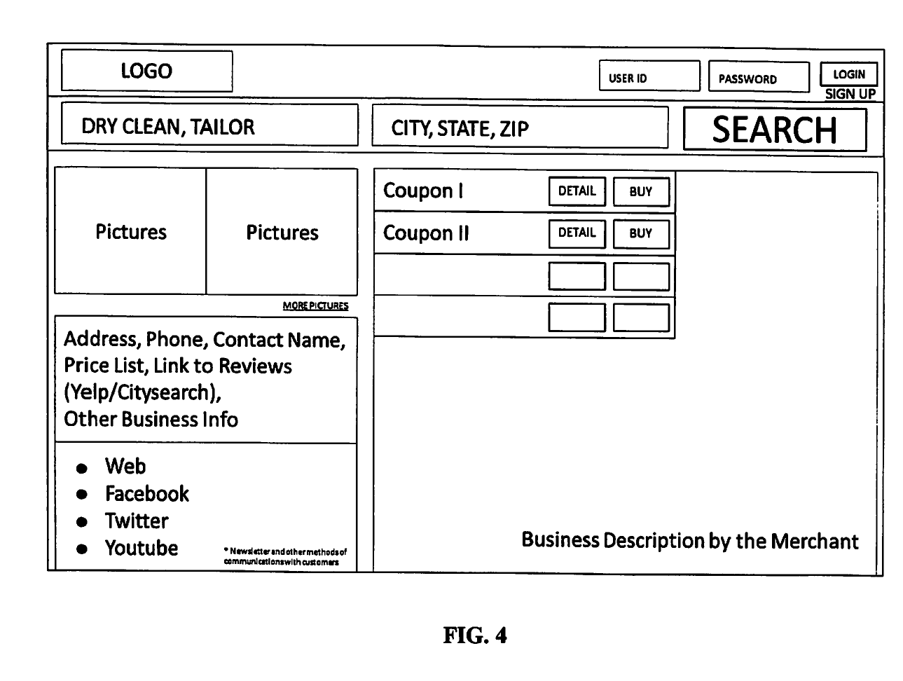

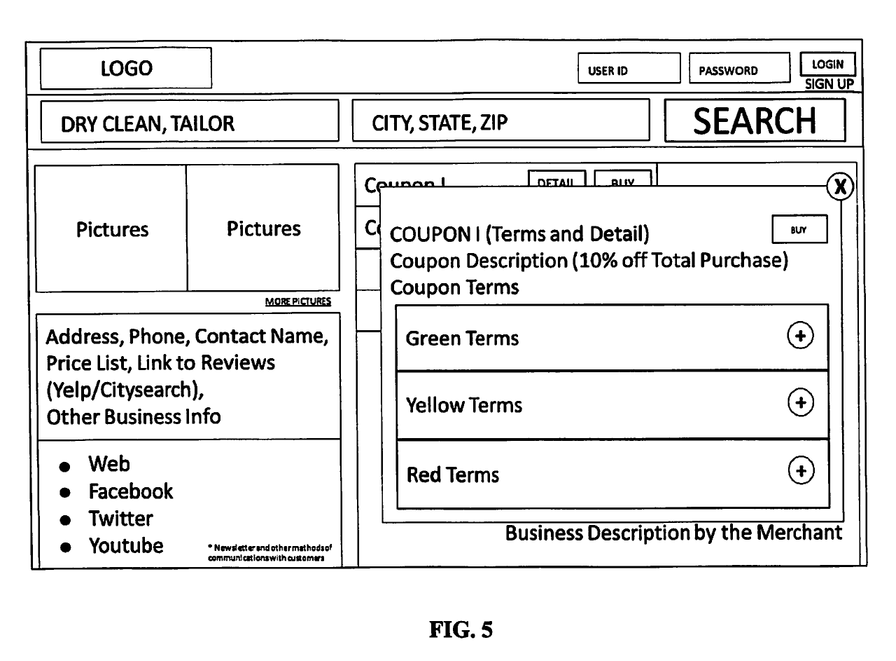

Once the consumers select a particular merchant or coupon offerings, Merchant Profile webpage as shown on FIG. 4 will appear. FIG. 4 illustrates an example of a user interface as Merchant Profile webpage that allows consumers to look at the detailed information of the merchant and the list of its coupon offerings. Merchant Profile webpage displays not only the information of the merchant, which includes its picture(s), address, phone number, business hour, reviews, and merchant's own website link, but it also lists available coupon offerings for purchase by the consumer. If the consumers choose a particular coupon from the list of the coupon offerings to see more detailed information, Coupon Information webpage as shown on FIG. 5 comes out on the Merchant Profile webpage. FIG. 5 illustrates an example of a user interface as Coupon Information webpage that allows consumers to check the information of the selected coupon. Coupon Information webpage displays the description, terms (Green, Yellow, and Red terms) and detailed information of the selected coupon.

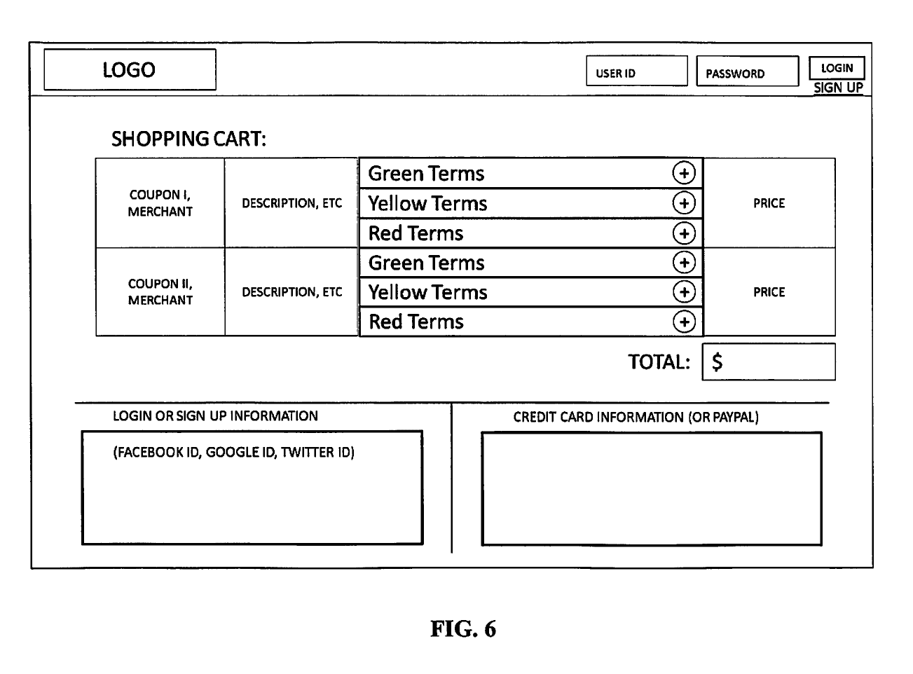

FIG. 6 illustrates an example of a user interface as Coupon Purchase webpage which allows consumers to check the coupons terms, review the price of the coupons in the shopping cart and to select the method of payment when purchasing the coupons. Then the consumers have an option to either continue shopping for other coupon, or make a payment to purchase the one time use coupon by either logging into the Consumer Account or paying by debit card or credit card.

Second way to search for coupons is to browse by the map button. Upon consumers clicking the Browse Map button, the consumer will be taken to a webpage with a Google Map API where the consumers can search through a list of popular merchants on a map and coupon offerings within the area. Consumers can click on the merchants or the coupon offerings to go into the merchant description webpage, which the consumers will have the option to purchase a one time use coupon, based on the coupon offerings by the merchants.

Third way to search for coupons is to browse by the category. CSP will organize the available merchants and coupon offerings into easily understandable categories for consumers to browse through. Upon finding the desired merchants or coupon offerings, the consumers can go into the merchant description page to continue to purchase one time use coupons.

Merchants may select the Go To Merchant Account link on the Main webpage as shown on FIG. 2 to go to Merchant Account webpage, which is displayed in a different color tone from the Main webpage. The different color tone shows whether the person browsing through the website can tell if he/she is in the Consumer Account view or the Merchant Account view. The Merchant Account webpage includes Merchant Account Log-In link, Merchant Account Registration link, and an introduction video for merchants to learn how to create and manage their own coupon offering(s), and what benefits they will have from the invention, upon registering for a Merchant Account. Merchants can sign up for Merchant Accounts to create, manage coupon offerings(s) and sell one time use coupons that fits to their needs and profit margins, add and manage their business information and pictures, and receive market data (customer data, coupon data, and merchant data) from the CSP. Merchants can log into their Merchant Accounts, if already registered, to make use of these options. The Merchant Account Registration page comprises four (4) main sections as follow: 1) user ID, password and financial information registration section, 2) business information registration section, 3) advanced business information registration section, and 4) coupon offering registration section.

Registration

There are two main types of registrations in the invention: Merchant Account Registration and Consumer Account Registration.

Merchant Account Registration

Registration for the merchants can be done in one of three ways; first via CSP website online by the merchants themselves, second, via the sales representative of the CSP over the phone or in person, or third, via U.S. Postal Mail, for those who does not have an access to the internet and/or to the CSP sales representative.

FIG. 7 is a flow diagram illustrating the process of Merchant Account registration. Referring to FIG. 7, the CSP generates Merchant Account registration webpage via Merchant Account webpage. A merchant must register for his/her Merchant Account in order to display business profile and coupon offerings on CSP's website. During the process of Merchant Account registrations, the merchant is required to fill out, but not limited to, a merchant questionnaire shown on Table 1. The process of Merchant Account registration has the main four (4) steps as follow:

First, the CSP requires the merchant to input his or her desired user name (ID), password, and financial information, such as bank account, debit card or credit card number, at input block 701 for an assurance that the merchant is legitimate and not trying to scam money from the consumers by creating a fraudulent account and sell unusable one time use coupons. The CSP then checks the availability of funds in the inputted financial account in decision block 702. If the funds are not available, the CSP requires the merchant to revise or input his/her other financial information.

Second, after the completion of the financial information check-up, the merchant is required to input his/her basic business information at input block 703 including, but not limited to, business name, address (location), contact person, headquarter office address if any, phone number, social network link, type of business, brief business descriptions, products/services offered, homepage web address, price list, pictures, and/or other financial information if not previously added. The list of the questions of the required basic business information is illustrated on Table 1. Price list can be useful as the consumers are likely to visit the store more if they can expect what to pay when they make a visit. The bank account information is added not only for a re-assurance that the merchant is an actual business, but also for a remittance of coupon sales minus the commissions from the CSP by payment transferring mechanism. The CSP will verify manually the existence of the business within the next a few days to make sure that the merchant is legitimate, but the merchant can create an account in order to proceed in making and selling coupons via coupon offerings.

Third, the merchant is also required to add advanced business information listed on Table 1, except for optional business information questions, at input block 704. The advanced business information may be asked with yes/no questions, multiple choice questions in ranges, and does not require exact values or numbers. This is to protect the merchant from sharing too much information to the competitor, but it can also help the merchant learn about the local market once CSP acquires and analyzes the information. The list of the advanced business information includes, but not limited to, the time in business (total business history), building type, approximate age of the building, last time the store was renovated, business square footage, number of employees, languages spoken, availability of computer and/or internet in store, and ownership of a smartphone if any. In addition, the merchant is asked to provide the CSP with his/her sales data range, which may includes foot traffic, approximate annual sales range, business physical size and inventory, in order to estimate and analyze the local market which they will be reported at the end of every month after CSP analyzes the aggregated data. This sales information is optional to be answered by the merchant; however, the merchant will be allowed to access other businesses' sales information only upon answering these optional questions. The business information collected from the questionnaire on Table 1 will be used to create market data for the merchant through Market Database Analysis Engine (MDAE), which will be provided to the merchants in various forms, such as printed reports and/or online analysis tools. As for the numbers, “range” would be asked, but not exact number. Information provided here will never be released as an individual data and will be aggregated before being shared with other merchant. In function block 705, the CSP verifies that all business information has been added and correct, and then the CSP adds the merchant on the Merchant Database in function block 706.

Fourth, the merchant generates coupon offerings following the terms and guidelines of the CSP at input block 707.

Merchant's Coupon Offering Terms

The invention provides merchants with the list of terms that they can select. This invention is made for the merchants who have or have tried promotion marketing for their businesses in the past, thus the list of terms and guideline helps them to easily create coupon offerings without further research of coupon marketing backgrounds. This type of method was chosen since not all businesses should be bound to “one-size-fits-all” coupon offering terms. The terms of coupon offering are marked in Red, Green, and Yellow, where Red indicates not-recommended terms for merchants, which consumers should watch out for; Green indicates recommended terms for merchant, which also benefits the consumers at the same time, and; Yellow indicates somewhere in between Red and Green Terms, which includes normal coupon terms. Table 2 illustrates an exemplary list of Red Terms, Green Terms and Yellow Terms of coupons from which the merchants can choose from while creating their own coupons. All of merchants, without exception, must choose one main coupon offering term and choose one or more of the optional coupon terms illustrated on Table 2. Each of merchants is allowed to create up to four (4) kinds of coupon offerings for his/her business.

Merchant's Coupon Offering Price

As long as merchants create their coupon offering terms with at least one of the coupon offering terms in Table 2, they can fix the price of the coupon offerings for sale to the consumers by themselves. The coupon offering itself does not act as a discount voucher, however, once consumer pays the fee designated by the merchant on the coupon offering price, consumer received a one time use coupon with a unique coupon number to use at the merchant's business location. This invention can be served to any type of businesses, small to large businesses, service to consumer products to business sectors, such as waste managements and/or building managements. This invention allows merchants to completely customize the coupon offerings terms, in order for them to meet their own specific needs, whether the coupon offerings are for consumers or businesses. However, the CSP advises them that the price of the coupon offerings to be offered within preferable range of $ 1 to $ 10.

The CSP verifies if all coupon offerings information inputted by the merchant is correct in function block 708. If the coupon offerings created by the merchant is satisfied within the provided guidelines of the coupon offerings by the CSP, the CSP adds the coupon offerings to Coupon Database in function block 709.

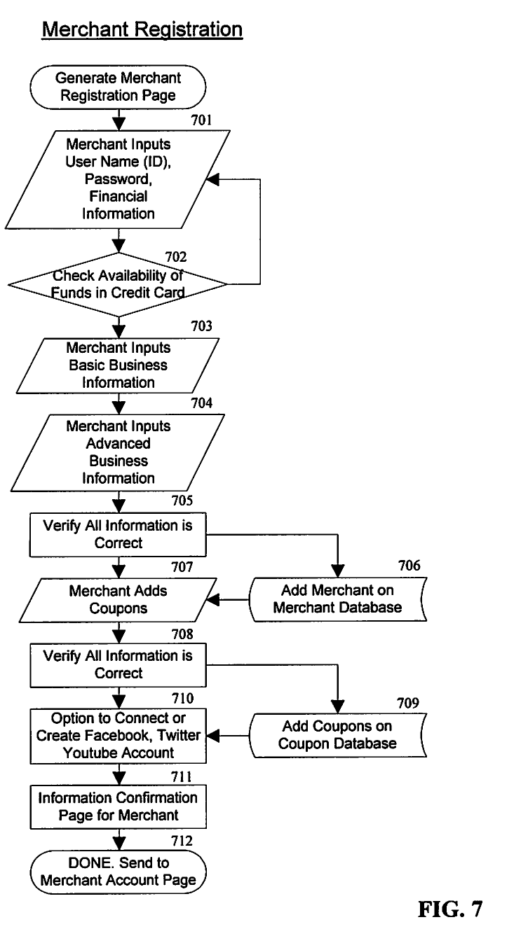

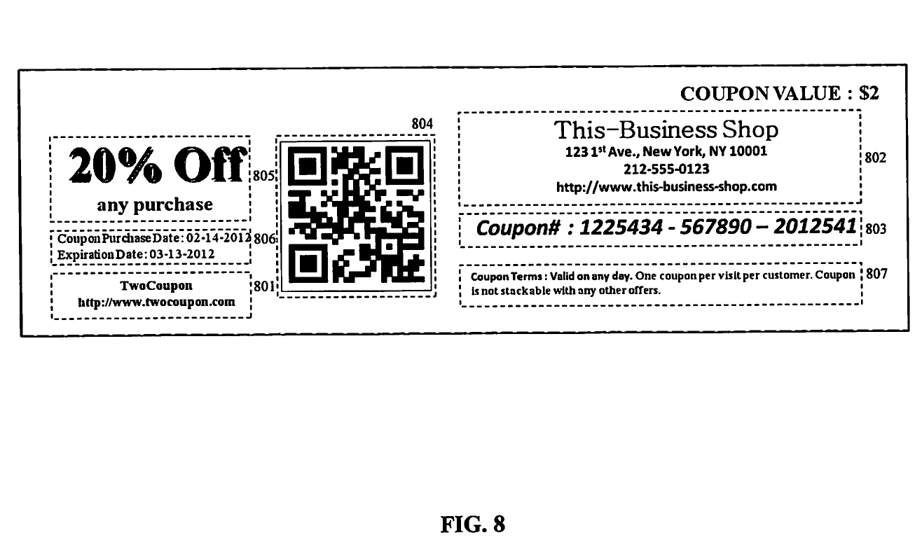

FIG. 8 is an exemplary screen display of a one time use coupon purchased by a consumer, which is based on the coupon offering terms and conditions created by a merchant. Referring to FIG. 8, an exemplary form of the coupon shows information of the CSP, such as name and website address, at 801, the merchant information (including the merchant's name, merchant's address, merchant's phone number and/or the merchant's website) at 802, the coupon identification number (comprising merchant number, consumer number, and coupon extension number) at 803, barcode or QR code at 804, the main coupon term at 805, the coupon purchase date and expiration date at 806, and the coupon terms and conditions of which the consumer should be aware at 807.

All coupons provided to the consumers after the purchase of the coupon offerings are only one time usable and each of them has its own unique coupon identification number generated by the CGE. Since the coupon identification numbers among coupons are unique and are all different from each other, consumers cannot use any one time use coupon more than once. This is to track when the coupon was purchase, who it was purchase from, when it was redeemed, which will be provided back to the merchant who created the specific coupon offerings in report format.

Last, the merchant has the option to link their social network accounts such as, but not limited to, Facebook, Twitter, Yelp and Youtube Account in decision block 710. If the merchant does not own any of these social network accounts and wants it created, the CSP will, upon merchant's request, create it for the merchant so the merchant can communicate with consumers through the social networking services. For merchants who are not familiar with creating the social network accounts, CSP will offer one-click service which will use the merchant's information from MICT to create social network accounts on behalf of the merchant.

After the completion of social network linking process, the merchant is sent to the Information Confirmation Page to review all the data inputted in output block 711. Once the merchant confirms all of the information inputted, the merchant is sent to Merchant Account webpage at output block 712. At the same time, the business information and coupon offerings will be listed on the website of the CSP.

Merchant Account Management

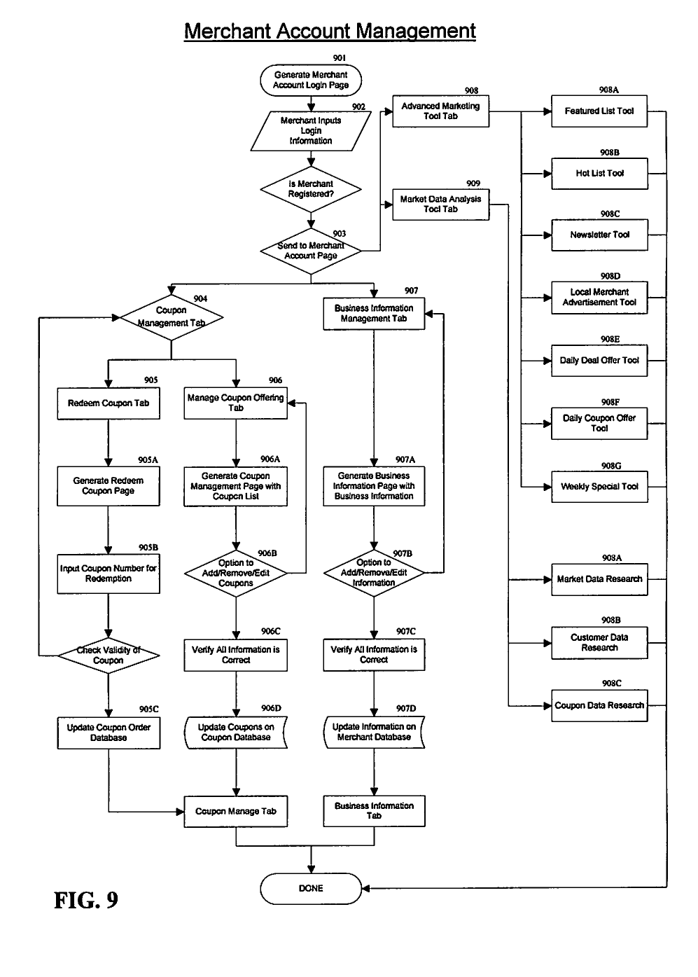

FIG. 9 is a flow diagram illustrating a process of managing the Merchant Account. Once the merchant has completed registering for a Merchant Account, Merchant Account webpage is generated at block 901. The merchant inputs his/her desired user ID and password to log into his/her Merchant Account at input block 902. The merchant is then sent onto Merchant Account management webpage at output block 903. As shown on FIG. 9, the Merchant Account management webpage comprises Coupon Management at block 904, Business Information Management tab at block 907, Advanced Marketing Tools (AMTs) tab at block 908, and Market Data Analysis Tool (MDAT) tab at block 909.

Through Coupon Management tab at block 904, Coupon Management webpage generates two (2) subtabs; Redeem Coupons tab at bock 905 and Manage Coupon Offerings tab, at block 906.

Through Redeem Coupons tab at block 905, Redeem Coupons webpage is generated with coupon number input boxes for redemption at block 905A. The merchant has the option to input the unique coupon number from the one time use coupon submitted by the consumer, which can be redeemed in decision block 905B. If the merchant inputs and redeems the one time use coupon in decision block 905B, the redeemed one time use coupons are updated on the COD in function block 905C, upon checking if the unique coupon number is valid by the CVE on CSP's web server. However, if the merchant cancels the action, the merchant is sent onto Coupon Management webpage. On Redeem Coupons webpage, the merchant can also look at the list of all previously redeemed one time use coupons via redeemed coupon history tab.

Through Manage Coupon Offerings tap at block 906, Coupon Management webpage is generated with coupon offering list at block 906A. The merchant has the option to add, remove, or edit coupon offerings in decision block 906B. Once the CSP verifies all the revised information of coupons in function block 906C is correct, the revised coupon offerings are updated on Coupon Database in function block 906D. The merchant is sent back to Coupon Management webpage.

Through Business Information Management tab at block 907, Business Information Management webpage is generated with the merchant's business information at block 907A. The merchant has the option to add, remove, or edit the business information in decision block 907B. The CSP verifies all the revised information is correct in function block 907C. The revised business information is updated on Merchant Database in function block 907D. Once the process is completed or canceled by the merchant, the merchant is sent back to Merchant Account webpage.

The merchant can manage, add, remove, or edit his or her coupon offerings and business information at any time without any fees or interruption from the CSP as long as the merchant satisfies the guidelines of the CSP. In regards to the expiration date of the coupon offerings, whereas the traditional and all existing coupon distribution businesses available in the market requires the merchants to put specific dates for the expiration dates, this invention allows merchants set a length of coupon's expiration days, which starts from the date of the one time use coupon was purchased by the consumers. For example, if a merchant chooses two (2) weeks expiration days within his/her coupon offering terms, the two (2) weeks starts from the date when the consumer purchases the coupon. So if the coupon offering was made on Jan. 1, 2012, unique one time coupon was generated on Feb. 14, 2012 when the said coupon was purchased by a consumer, then the expiration date of this specific one time use coupon will be on Feb. 28 of 2012, which is two (2) weeks from the moment consumer purchases the one time use coupon.

Advanced Marketing Tools (AMTs)

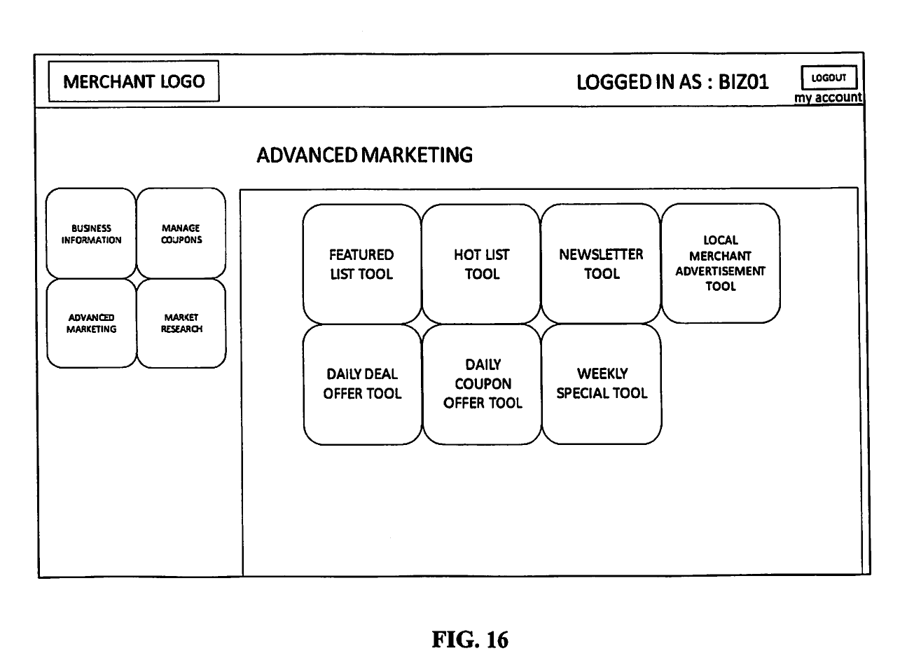

Through Advanced Marketing Tools (AMTs) tab at block 908 of the Merchant Account, a merchants can participate in additional marketing options, other than providing regular coupon offerings to the local consumers. AMT is where the merchants pay, instead of the consumers, to the CSP in order to increase the awareness of the merchant as well as the coupon offerings. AMTs will be used to communicate between the merchant and consumers via e-mail, CSP website, Social Networking Website, as well as direct mail forms (traditional U.S. Postal Mail). AMTs—comprises Featured List Tool tab at block 908A, Hot List Tool tab at block 908B, Newsletter Tool tab at block 908C, Local Merchant Advertisement Tool tab at block 908D, Daily Deal Offer Tool tab at block 908E, Daily Coupon Offer Tool tab at block 908F, and Weekly Special Tool tab at block 908G FIG. 16 illustrates an example of a user interface as Advanced Marketing Tools webpage.

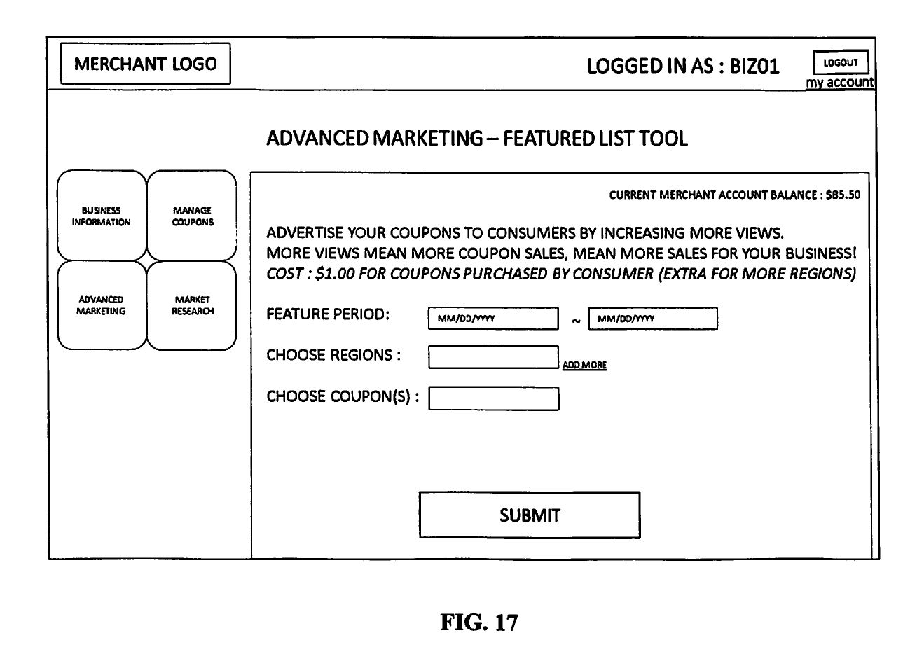

Through Featured List Tool tab at block 908A, a merchant can have an option to promote their coupon offerings via daily emails and on the website of the CSP. Consumers can sign up or log in to view the list of the featured coupons around the consumer's desired location, and/or consumers can also see the featured coupons by searching through a specific region with or without signing up or logging in. When the search result appears, featured coupons will have a special color tone so that it can be distinguished from the non-featured coupons. Featured list will be only shown to the specific consumers, based on the zip code inputted by the consumer. This will increase the awareness of the business and the coupon offerings to the local consumers. Featured List is a sponsored coupon offering list from a merchant, where the merchant pays additionally to utilize this tool. Every time a featured list of coupon offerings are sent via email, there will be a limited number of featured list coupon offering spaces, possibly from 5 to 10, and a link to the webpage of the CSP to see the rest of the Featured List on the website. It will cost extra to the merchant to be listed on the email rather than to be listed in the webpage only. The Featured List will be different for each of the consumers depending on the location the consumer has added in his/her account during Consumer Account registration process. This option can be paid with prepaid credits by the merchant. In the featured list, the CSP requests the merchant to give 25% or more discount, although not required, to their goods/services offered, thus the consumer would be interested in seeing the coupon offerings on the Featured List. FIG. 17 illustrates an example of a user interface as Featured List Tool webpage that allow merchants to choose feature period, regions, and coupons for advertising.

Through Hot List Tool tab at block 908B, a merchant can review the requirements of how to feature coupons on the Hot List and be advised on how to increase the chances of listing his/her coupon offerings on the hot list. Via daily email and on the website of the CSP, merchant's hot list coupon offerings will be displayed on the front page. Hot list will be shown only to the local consumers, based on the zip code inputted by the consumer. Hot list is a list of coupons which the coupon has been very popular among the consumers compare to other coupons within that local area. This will increase the awareness of the business and the coupons to the local consumers. There will be a daily hot list, a weekly hot list, and a monthly hot list. Because of limited spaces, the rest of the hot list can be viewed from the page link in case the consumer received the list via email format. There is no cost to be listed on the hot list for merchants or consumers. Although the service is free to the merchants, unlike other AMT tools, it must meet certain criteria including popularity by days, weeks, and months in order to be featured. This will create a reason for merchant to provide more attractive coupon offerings and may require additional work, frequent access to CSP, and managing coupon offerings more frequently.

Through Newsletter Tool tab at block 908C, newsletter tool will be used as a communication tool between the merchants and loyal customers. Newsletter tool is used to help merchants to connect to consumers, while the consumers get to learn more about the local businesses and get special offers from the merchants. Newsletter is part of the daily and/or weekly email consumer receives along with the Hot List, Featured List, Daily Deal Offer, and Daily Coupon Offers. Consumers' default option of Merchant's Newsletter is to receive from all merchants that the consumers have bought coupons from. However, if the consumers are not comfortable with the newsletter they receive, they can choose not to receive the Merchant's Newsletter in their email inbox. Once the customer agrees to receive newsletter from the chosen merchants, the customer will receive newsletter from the merchants whenever the merchants write letters to their loyal customers. Merchants can use this tool to inform customers of new coupon offerings, specials, as well as new information about their businesses. As for consumers, consumers would only receive one aggregated and customized email from all of their favorite and registered merchants which they have purchased coupons from, whether it'd be one or twenty different merchants. This reduces the junk mail received by the consumers, while still being updated from their favorite local merchants or merchants they have visited previously by purchasing one time use coupons from the CSP. Merchants will pay additionally to utilize this tool, and will be charged per email sent to the consumers. If a merchant only wishes to reach only 100 local customers out of 1,000 local customers whom they have sold the coupons to, he/she may have the option to do so to conserve the marketing budgets. The merchant can choose a particular group of consumers by gender, age group, for example, female between the ages of 18 to 24, to send the newsletter to such group. Only one aggregated newsletter for all merchants is sent in one single email, so the consumer does not have to worry about getting 50 emails from 50 different local merchants every day, which can turn into a spam mail. Merchants do not have to write newsletter every day, but rather only pay when they wish to write to the customers to whom they wish to send the newsletter to. Each merchant's newsletter may include links to email or share on social networking sites, so that the consumers can share the news with their friends. Newsletter will have base formats and frames which merchants can choose from, thus the merchants only need to submit the writing and the date when the newsletter is to be sent.

Through Local Merchant Advertisement Tool tab at block 908D, the merchant can promote their business by sending out one time use coupons via email or by U.S. Postal Mail to chosen consumer categories. Merchant will pay additionally to utilize this tool. This specific tool allows the merchants to choose whom they wish to send the one time use coupons to and when, via email or using the option of traditional U.S. Postal Mailing distribution. For example, merchants can choose female between the ages of 18 to 24, who have purchased one time use coupons to a Spa in zip code 10001, which the merchants deem their targeted market, then the CSP will send out one time use coupons via email and/or U.S. Postal Mails to those specific customer categories. This allows the invention to create a targeted advertising and integrate it into the local offline markets in the traditional coupon distribution format, by mailing out the coupons to specific consumers only.

Through Daily Deal Offer Tool tab at block 908E, CSP will send out daily emails along with one local deal over 50% (i.e. $50 restaurant gift certificate for $25). Merchants can utilize this tool to offer special deals to local customers for an additional fee, which will be taken out of merchant's prepaid account.

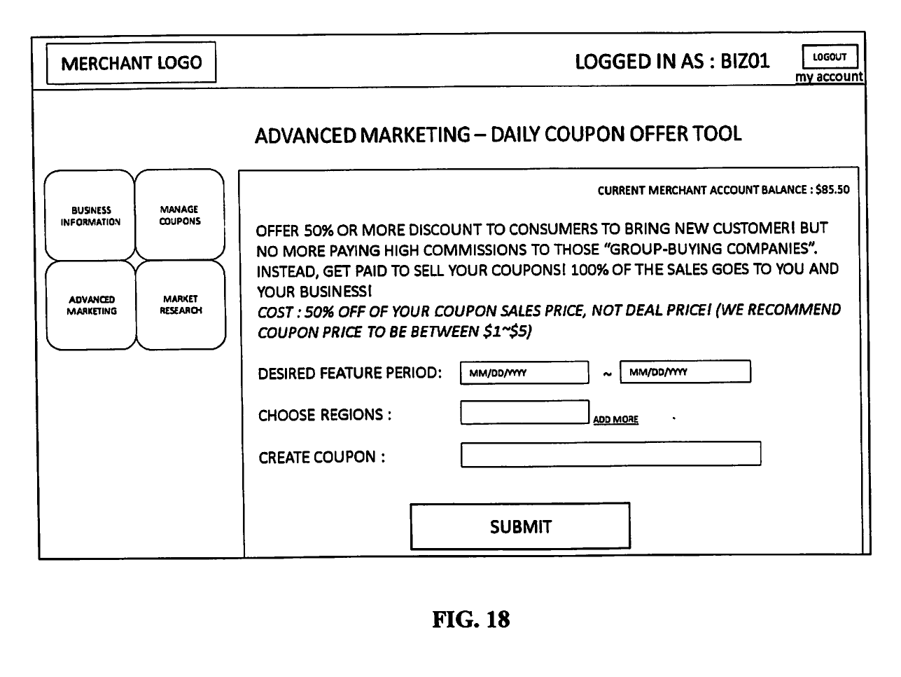

Through Daily Coupon Offer Tool tab at block 908F, CSP will send out daily emails along with local coupon offerings that carry the discount of over 50%. Unlike the Daily Deal Offers available in the market, this invention lets merchants to offer discount coupons instead of deals or gift certificates. One time use coupons will be sold between the prices of $1 to $10. By selling coupons (in example 10% off, or $5 off of $20 purchases) instead of deals or gift certificates (in example, pay $30 for $60 worth of services), merchants do not have to pay high commissions based on the price of the deals, which are often between 30% to 50% of the deal prices (in example above $10-15), and consumers don't have to pay high-cost deal purchases upfront (in example above $30). In other businesses' daily deal offer sites which offers deals or gift certificates, merchant pays up to 50% of the sales revenue of the deal sales as a commission to the CSP, and consumers must pay a lot of cash upfront before visiting the merchant. However, in this invention, by selling and purchasing coupons, merchant pays no commission from the actual sales generated by the consumer, and the consumer pays the cost of the product or services at the time of visiting the merchant in person, and not upfront. FIG. 18 illustrates an example of a user interface as Daily Coupon Offer Tool webpage that allow merchants to choose desired feature period and regions, and to create coupon offerings for the daily coupon offer.

Through Weekly Special Tool tab at block 908G merchants can use to boost temporary sales to get new customers. Like those of the weekly special given by the grocery businesses and pharmacy businesses, each merchant can offer special sale coupon offerings to see his/her sales numbers grow temporarily, aside from his or her regular coupon offerings. The merchant should provide more significant discount or discount offer value better than the regular coupon offerings in order to utilize the weekly special tool. Weekly Special coupon offerings can be very useful for clearing the un-selling products of the merchants, for lowering the inventory, or increase temporary foot traffic. “Weekly Special” logo will be featured next to the coupon offerings within the CSP page in order to gain more visibility among other coupon offerings.

Market Data Analysis Tool (MDAT)

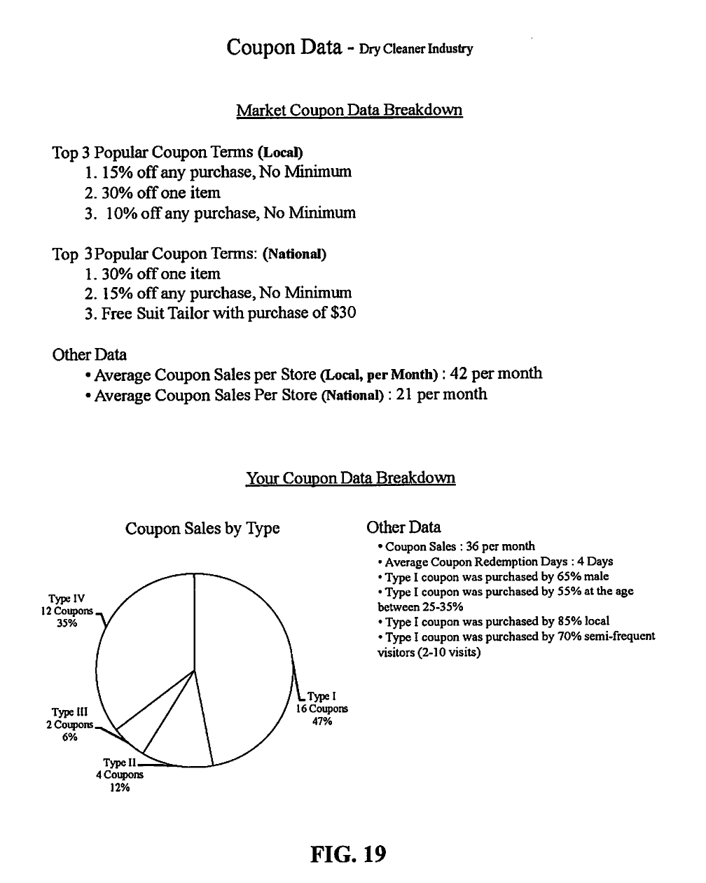

Through Market Data Analysis Tool (MDAT) tab at block 909, MDAT is comprised of Market Data Research tab at block 909A, Customer Data Research tab at block 909B, Coupon Data Research tab block 909C. MDAT will be available for merchants to analyze local market data any time on the CSP's website. Unlike the large corporations with millions of dollars of market research budget, small and medium sized businesses cannot make this type of investments. As a result, these merchants do not know who to target, how much to invest in marketing budget, and/or how to provide an effective marketing promotions. The present invention understands and captures this gap in the market. MDAT is a sophisticated, intelligent data analysis tool which lets merchants to analyze the local markets and consumers, and figure out the potential ways to grow their businesses. Market Data Research tab at block 909A allows merchants to learn about the local and national markets, such as the local social characteristics, economic characteristics, demography, local competitions, local customer characteristics. The data used to report to the merchants will be from the Market Database, which is integration of coupon sales in the local markets, registered merchant database, registered consumer database, and U.S. Census Data, almanac data, and/or other free or paid government data or statistics. Customer Data Research tab at block 909B allows merchants to learn about their own customers who purchased merchants' one time use coupons through the CSP's website. Information will include, but not limited to, the age group of the customers, gender group, and the frequency of the coupon purchases. The data used will be from one time use coupon sales data in Coupon Order Database. Coupon Data Research tab at block 909C allows merchants to learn about the coupons offered by other merchants and find out what types of coupon offerings were popular and which types of coupon offerings to avoid. By categorizing the industries and regions, merchants can use this tool to offer effective coupon offerings that will create one time use coupon sales and increase customers foot traffic. The data used will from one time use coupon sales data in Coupon Order Database and Coupon Database. FIG. 19 illustrates an example of coupon data for merchants in dry cleaner industry.

The MDAT data will provide reports to the registered merchants in a printed format for free of charge every month and available online at any time. However, the merchants can choose to join its premium service for a fee to access the advanced market data, which analyzes wider range of data. Unlike the MDAT basic service, which limits the access of information by the location of the regions' geography and industry, the advance market data does not limit the data access by the region or other categories, and provide the nationwide data to the merchant. With this type of information, the merchants can decide whether to invest more in the marketing budget to increase same store sales, expand their current shop to accept more customer at once, renovate their shop to compete against competitors, open a new shop a new location, and/or help with other minor and major business decisions.

MDAT will gather information from three different sources. First, it will be from the U.S. Census Data, almanac data, and/or other free or paid government data or statistics. The CSP will list every city with population, number of businesses, median income, demography, as well as almanac information. Although many of these types of information is free from the government websites, the information is often organized in hard to understand format. The second source of data will be from the merchant questionnaire, which the merchant was asked to fill out during the registration process. This information allows merchants to compare its businesses to the competitors in the local market through Market Data Research tab at 909A. Third source of data will be from the coupon sales. By keeping a record of which consumers bought which types of coupons from which merchants, MDAT can analyze the consumer patterns and traffic in any region down to the cities. By aggregating the above three types of information into one easy to read format, MDAT will allow merchants to gain knowledge on two of the most important information in running a business: the market information and the customers information.

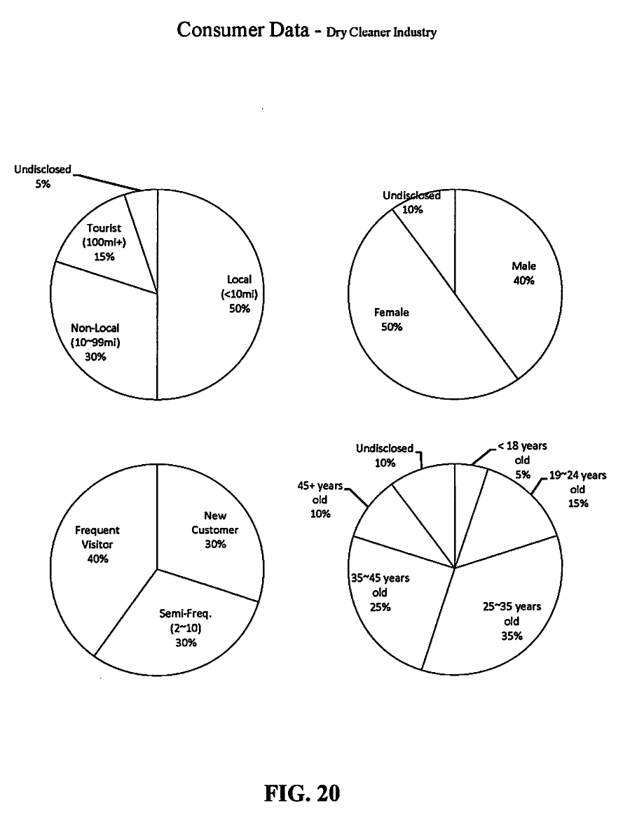

Through MDAT, Customer Data Research tab at block 909B, the merchants can access detailed information about the businesses' customers including, but not limited to, the number of one time use coupons bought, location of the customer where it was bought from, number of coupons purchased per customer, and what types of coupons were popular which were offered by the merchant. By knowing more about their own customers, the merchants can spend capital more effectively when investing in marketing, inventories, and/or expansion. This type of information can also help merchants to estimate potential customers and potential market size. FIG. 20 illustrates an example of consumer data for merchants in dry cleaner industry in the form of a pie chart.

Through MDAT, merchants can also learn more about the competitors including how many competitors exist in his/her local markets, the competitions' type of coupon offerings, how long the competitors' businesses were opened, or even when the last renovation was done, which are collected during merchant registration's questionnaire process. By knowing about the competitors, the merchants can effectively plan ahead for future business decisions.

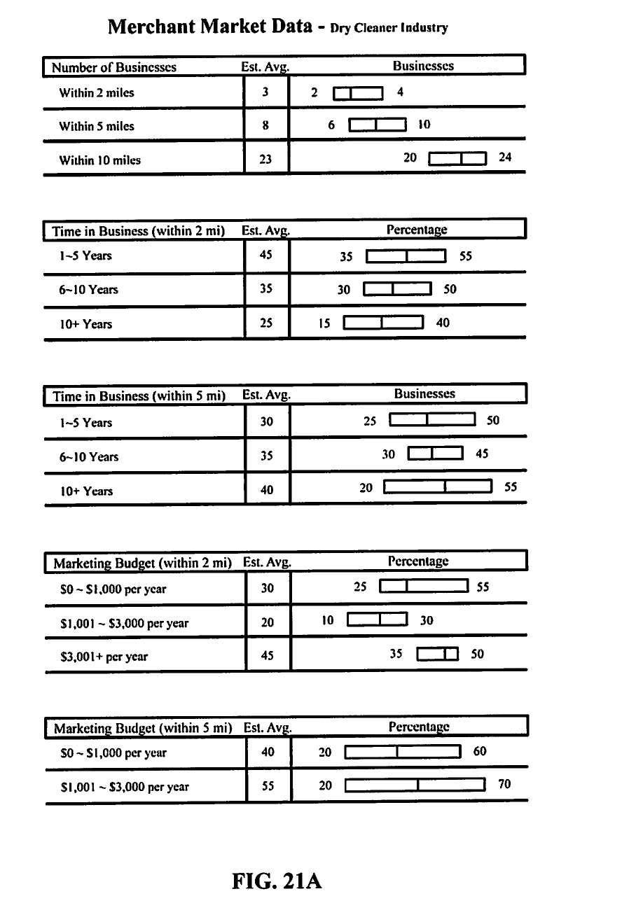

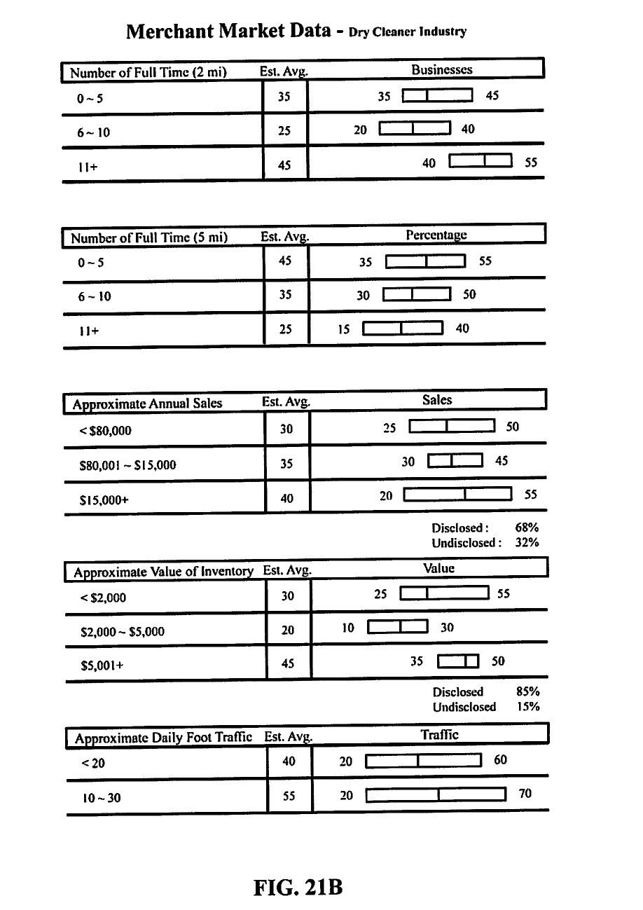

Competitors' data provided through the market data to the merchants will be in aggregated, generalized, and in the range format. By giving the data in ranges, the business can protect its privacy, while still obtaining local market data. With the data obtained as above, the merchants can compare and analyze their own businesses against its competitors to improve their own businesses. Market data is provided to the merchants in either narrative form, chart form, and/or graphic form. FIGS. 21A and B illustrate examples of graphic charts of market data for merchants in dry cleaner industry.

Consumer Account Registration

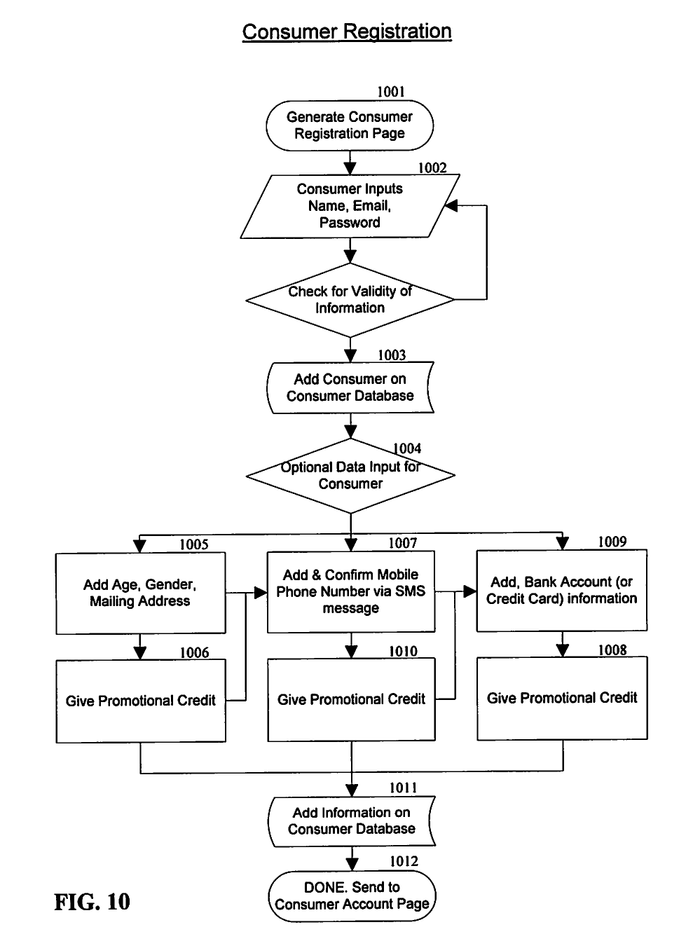

FIG. 10 is a flow diagram illustrating a process of registering for a Consumer Account. Referring to FIG. 10, once Consumer Account Registration webpage is generated at block 1001, consumers are first required to input their user name (ID) and password as well as their basic personal information including their name and email address at input block 1002. Then, the CSP gives the consumers instant gratification for their registered Consumer Account and adds them on Consumer Database in function block 1003. The consumers are also given an option to add more of their personal information including age, gender, mailing address, mobile phone number, bank account, and credit card or debit card number in decision block 1004. If the consumers add their age and gender, and mailing address at input block 1005, the CSP provides them with a promotional credit to spend on their coupon purchases, preferably $ 1 to $ 3 at output block 1006. If they add their mobile phone number via Short Message Service (SMS) at input block 1007, the CSP provides them with another bonus credit, preferably $ 1 to $ 3 at output block 1008. If they add bank account, debit card, or credit card information at input block 1009, the CSP provides them with the credit, preferably $ 1 to $ 3 at output 1010. After the consumers are finished with adding the optional information, the information is automatically added on Consumer Database in function block 1011. The consumers are then sent to Consumer Account webpage at block 1012.

To ease the process of Consumer Account registration process, the CSP has an option to integrate Facebook identifications, Google identifications, Twitter identifications, and/or other Open identifications for public use. Using this type of registration process enables a quick sign-up and also gives more information back to the CSP. It also makes it easy to share coupon offerings and one time use coupon purchases for the consumers, leading to social network marketing for the CSP as well as merchants.

Consumer Account Management

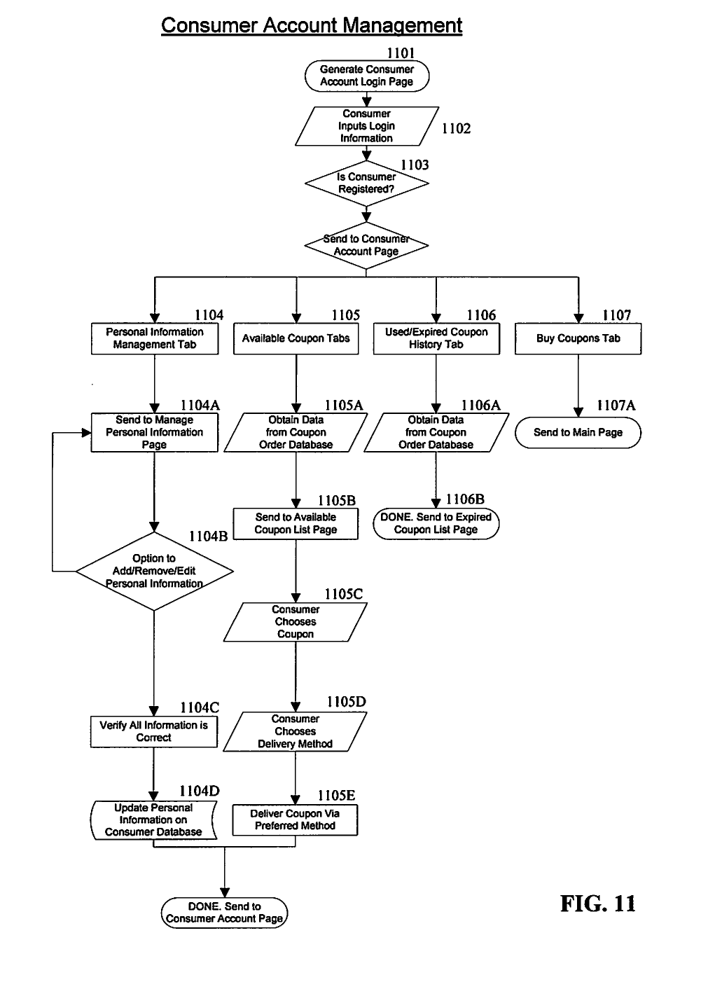

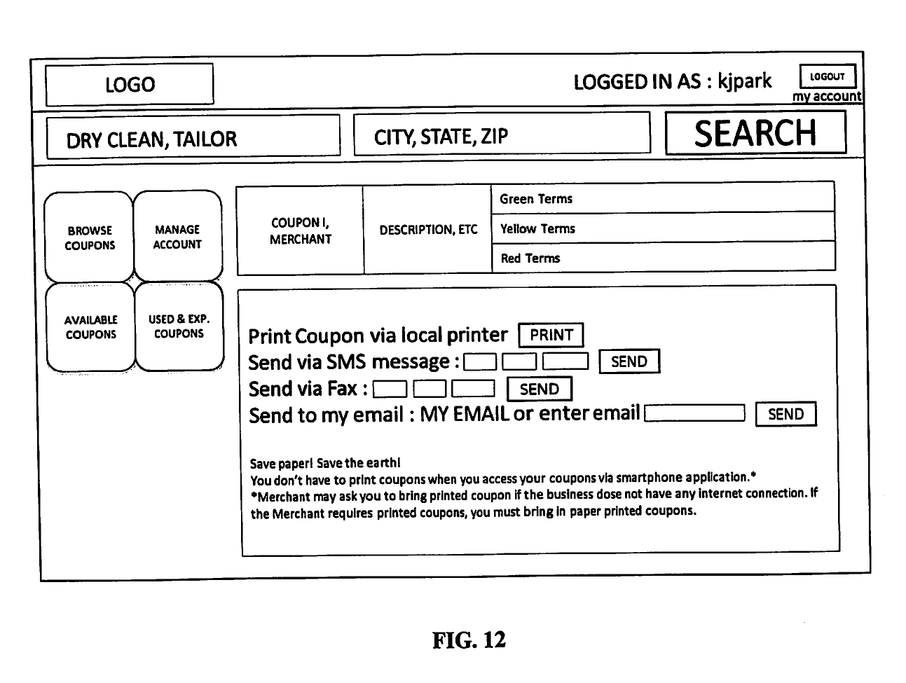

FIG. 11 is a flow diagram illustrating a process of managing the Consumer Account. Referring to FIG. 11, once a consumer registers for a Consumer Account, the Consumer Account Log-In webpage is generated at block 1101. The consumers first input their log-in information (user ID and password) at input block 1102 and then they are sent to Consumer Account webpage at block 1103. On the Consumer Account webpage, the consumers can manage their personal information and purchased one time use coupons on the Consumer Account webpage. The Consumer Account webpage is comprised of Personal Information Management tab at block 1104, Available Coupon tap at block 1105, Used/Expired Coupon History tab at block 1106, and Buy Coupon tab at block 1107. Through Personal Information Management tab at block 1104, the Personal Information Management webpage is generated at block 1104A. The consumers have the option to add, remove and edit their personal information in decision block 1104B. After the CSP verifies that the revised information is correct in function block 1104C, the information is updated on the Consumer Database in function block 1104D. Through Available Coupon tab at block 1105, the CSP retrieves one time use coupon data from Coupon Order Database in function block 1105A, which the consumers can view at Available Coupon List webpage at block 1105B. In this page, the consumers can obtain a list of purchased, but unused one time use coupons. Then the consumers can choose the coupon(s) from the available one time use coupon list to re-access the coupons purchased earlier to redeem the coupons(s) at decision block 1105C, and also allows him/her to choose one of coupon delivery methods in decision block 1105D. The coupon delivery methods include printing on a local printer, send via email, SMS, or fax as shown on FIG. 12. FIG. 12 illustrates an example of user interface that allows consumers to choose one of multiple coupon delivery methods. The consumers can reprint coupon(s) in any delivery method as long as the one time use coupon(s) are purchased, unused and unexpired. The one time use coupon(s) are delivered via the preferred method chosen by the consumers at output block 1105E. Through Used/Expired Coupon History tab at block 1106, CSP retrieves coupon data from Coupon Order Database in function block 1106A, and the consumers are sent to Used/Expired Coupon webpage to obtain used/expired one time use coupon data in function block 1106B. This allows consumers to see which merchants they visited in the past and/or option to repurchase the coupons from the merchants without going through the Coupon Search webpage, as long as the same coupon offerings are still available. Through Buy Coupon tab at block 1107, the consumers are sent to Main Consumer Account view webpage to search and purchase coupons at block 1107A.

Coupon Purchase

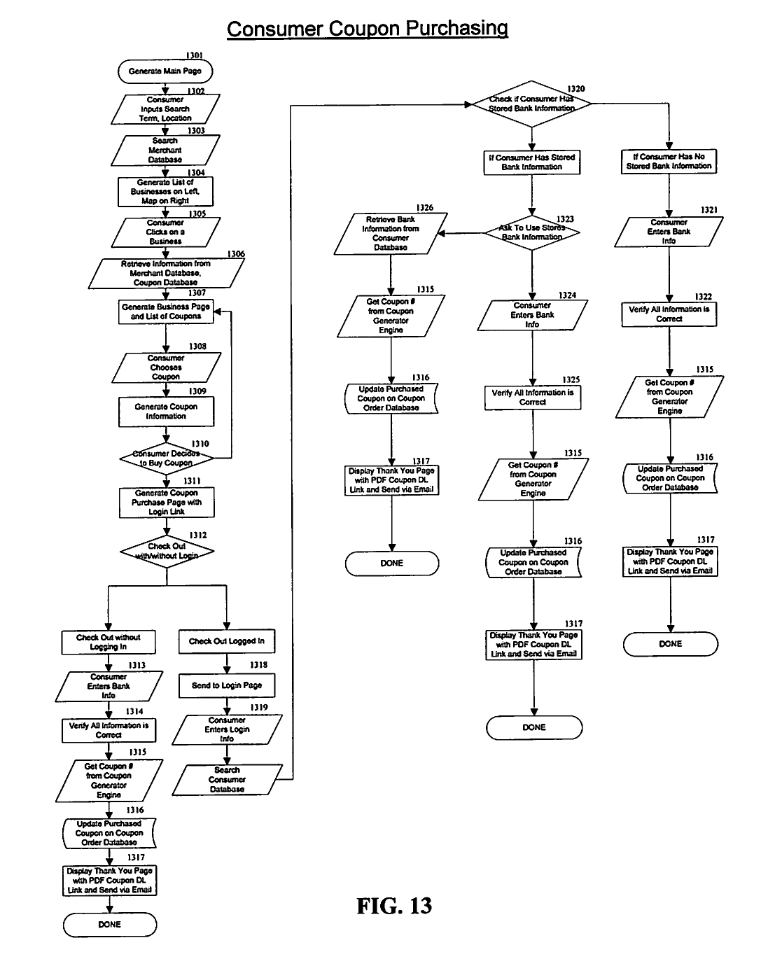

FIG. 13 is a flow diagram illustrating a process of purchasing coupons. Referring to FIG. 13, once Main webpage is generated at block 1301, the consumers input type of business on the search term box and the name of the city, state, and/or zip code on location box on the Main webpage at input block 1302. The CSP searches merchants and/or coupon offerings in Merchant Database via MICT in function block 1303 and then generates list of merchants as well as their business locations on a map at output block 1304. After the consumers select a particular merchant or coupon offerings on the list in decision block 1305, the information of the merchant is retrieved from Merchant Database and Coupon Database through MICT in function block 1306. The CSP generates the Merchant Profile webpage and list of its coupon offerings at output block 1307. Merchant Profile webpage includes merchant description, consumers' reviews, pictures, and/or link to businesses' social networking accounts, if any, as shown on FIG. 4. When the consumers choose one of the list of coupon offerings in decision block 1308, Coupon Information webpage as shown on FIG. 5 is displayed on the Merchant Profile webpage at block 1309. Coupon Information webpage displays the description, terms (Green, Yellow, and Red terms) and detail information of the selected coupon offering. If the consumers decide to buy a one time use coupon based on the coupon offering at decision block 1310, Coupon Purchase webpage as shown on FIG. 6 is generated with Consumer Account log-in link at output block 1311.

The consumers have an option to decide to purchase the coupons either with or without logging in to the Consumer Account on Coupon Purchase webpage in decision block 1312. In one case of purchasing the coupons without logging-in, the consumers enter their bank account, debit card or credit card information at input block 1313. Then CSP verifies that the information is correct in function block 1314. Once all information is verified, the CGE generates a unique coupon identification number for every coupon purchased and consumers get a one time use coupons with a unique identification number at output block 1315. At the same time, the purchased coupon is updated on Coupon Order Database (COD) in function block 1316. Coupon Order Confirmation webpage is then displayed with coupon's terms and conditions and the one time use coupon is sent to the consumers via email in function block 1317.

In the other case of purchasing the coupon with log-in credentials, the consumers are sent to the Consumer Account log-in webpage at block 1318. The consumers then enter log-in information (user ID and password) at input block 1319. The CSP searches Consumer Database and checks if the consumers have their stored bank account, debit card or credit card information in decision block 1320. If consumers have no stored the bank account, debit card or credit card information, they may enter a bank account, debit card or credit card information at input block 1321 and the CSP verifies if the information is correct in function block 1322. Once the payment process is completed, the consumer receives or gets an access to one time use coupon with a unique identification number generated from CGE at output block 1315. At this time, the purchased coupon is updated on the Coupon Order Database in function block 1316. Coupon Order Confirmation webpage is then displayed with the coupon, along with a unique coupon number, and instructions on how to redeem the coupon, which is also sent to the consumer via email in function block 1317.

If consumers have the stored bank account, debit card or credit card information, they may decide whether to use the stored financial information or not in decision block 1323. If not using the stored financial information, the consumers must enter a new bank account, debit card or credit card information at input block 1324 and verify the information is correct in function block 1325. Next, the consumers receive a one time use coupon with its unique identification number generated from CGE at output block 1315. At this time, the purchased one time use coupon is updated in the Coupon Order Database in function block 1316. Coupon Order Confirmation webpage is then displayed with the coupon, along with a unique coupon number, instructions on how to redeem the coupon, which is also sent to the consumer via email in function block 1317. If using the stored financial information, the stored information is retrieved from Consumer Database in function block 1326. Then the consumers receive a one time use coupon with its unique identification number generated from CGE at output block 1315. At this time, the purchased one time use coupon is updated in the Coupon Order Database in function block 1316. Coupon Order Confirmation webpage is then displayed with the coupon, along with a unique coupon number, instructions on how to redeem the coupon, which is also sent to the consumer via email in function block 1317.

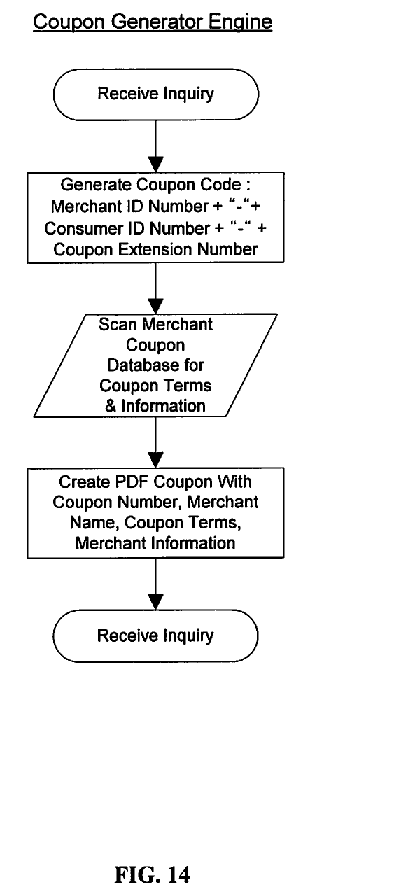

FIG. 14 is a flow diagram illustrating a process of generating a one time use coupon with a unique identification number by Coupon Generator Engine (CGE). Referring to FIG. 14, when a consumer purchases a one time use coupon from a merchant based on the coupon offerings by the merchant, CGE receives a request to create a one time use coupon with a unique coupon number. Instead of generating a random coupon identification number, CGE generates coupon identification number for the coupon by integrating the merchant number, the customer number, and a coupon extension number, of which merchant and customer number is created during each registration processes, into the coupon identification number in order for merchants and consumers easily to keep track of the coupons. CGE scans the coupon terms and information of the merchant from Coupon Database, which is used to create a one time use coupon including a unique coupon identification number, the coupon terms, the merchant name, and other merchant information.

Coupon Redemption

In addition to website's user interface for both merchants and consumers, the present invention includes a mobile interface for merchants and consumers. Merchants can use any mobile device or smartphone to scan the bar code or Quick Response (QR) code on the one time use coupon to validate the coupon. Instead of making merchants to purchase expensive equipment which connect to another high cost computer system, a simple downloadable mobile application will act as a bar code or QR code reader. The smartphone or iPod Touch-like devices must be connected to the internet in order to verify the coupon in real time. There will be an option to scan the unique coupon code either with or without an internet connection, but scanning the code without an internet connection will not validate the code in real time. Smaller merchants who do not have internet connection at the shop can utilize this option. In consumer mobile application, consumers can buy, manage and redeem coupons on a mobile device instead of printing the one time use coupons on paper. Used one time use coupons and unused one time use coupons have easy-to-tell distinguishable features as well as the list of merchant's coupon terms and other merchant's information. As for purchasing a one time use coupons on the mobile devices, consumers can scan through their geo-location services to find out which shops are nearby in order to get the discounts and/or use one time use coupons.

After a consumer purchases a one time use coupon based on the coupon offerings, either on mobile devices (laptop, smartphone) or non-mobile devices (desktop), the consumer can choose to receive the one time use coupon in two different forms: printable version or electronic version. Except for SMS delivery, each of the coupons will include a bar code or QR code with a series of unique identification numbers. If the printed coupon is lost, the consumer can log into the Consumer Account to reprint the one time use coupon or resend the coupon via email or other methods. Used and unused one time use coupons are managed by the CSP through the CSP Coupon Order Database server, not by the merchant. This centralizes the coupon information on the CSP server, thus the consumer can always access the used and unused one time use coupons, anywhere and anytime, and merchants would not have to keep track of every one time use coupon that are redeemed or not redeemed.

The terms and conditions of the coupon offered by the merchant are printed within the one time use coupons. As long as terms and conditions of the coupons are met, the consumer can redeem the one time use coupons at the merchant's business location, described in the merchants' terms and conditions on the coupon offerings. The purchased one time use coupons can be managed online by the consumer and printed at any time. Used coupons will also be indicated in Consumer Account view, and data of when the coupon was purchased, when it was used, and/or when it will expire or has expired.

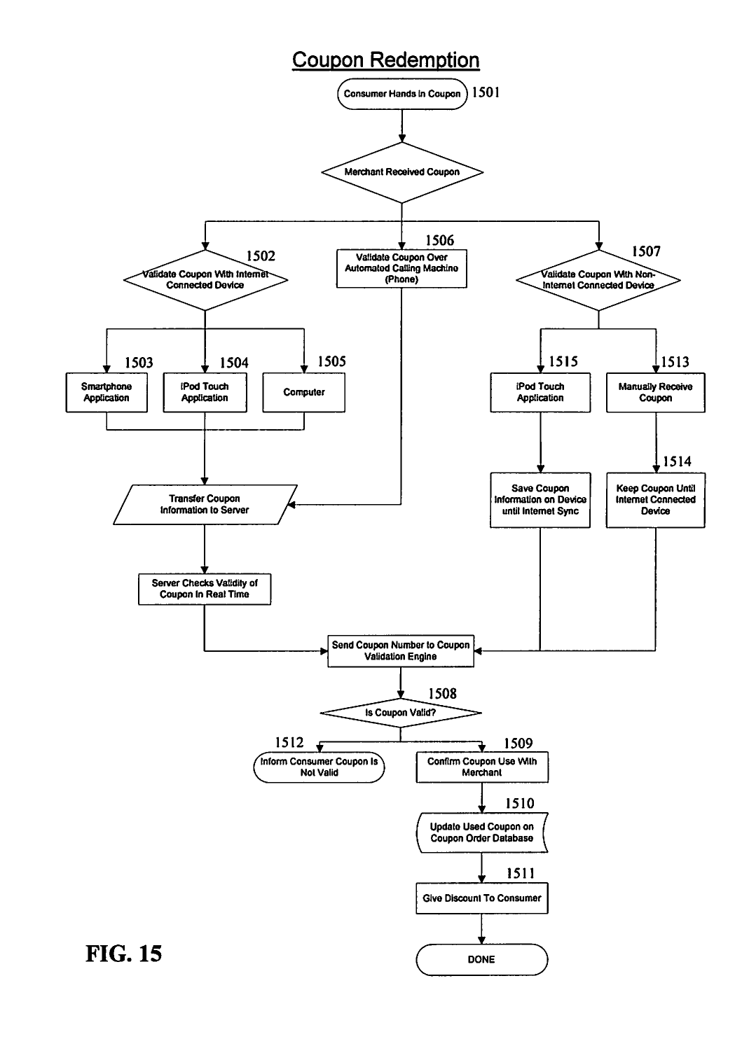

FIG. 15 is a flow diagram illustrating a process of redeeming a cone time use coupon. Referring to FIG. 15, once a consumer delivers a one time use coupon to a merchant at the point of sale at input block 1501, the merchant validates the said coupon in one of three ways. One is to validate the said coupon with interne connected device in function block 1502 such as smartphone application at block 1503, iPod Touch application at block 1504, and computer at block 1505. Another way is to validate the said coupon over APSC in function block 1506. The other is to validate the said coupon with non-internet connected device in function block 1507. CVE checks the validity of the one time use coupon in decision block 1508. If the said coupon is valid, CVE confirms the use of the said coupon with the merchant in output block 1509. At the time, the used one time use coupon is updated on COD in function block 1510. The merchant accepts the said one time use coupon and gives a proper discount to the consumer at output block 1511, as described according the terms and conditions of the coupon offerings which the one time use coupon was derived from. If the said one time use coupon is not valid, CVE informs the merchant of the invalidity of the said coupon at output block 1512. Such case can include, but not limited to, one time use coupons that are already redeemed previously, expired one time use coupons, and/or unique coupon code that are not generated from CSP's CGE. Scanning and validating the one time use coupon is an important task for the merchant as this will be used keep track of the coupon buyers and provide consumer data back to the merchant.

Instead of purchasing a bar code reader from the CSP, the CSP utilizes the system that is already available to the merchants without any extra upfront costs, such as mobile phone with CSP's mobile applications installed and/or internet connected computers.

In the case of validating the coupon with internet connected mobile device with an application, such as smartphone application at block 1503 or iPod Touch application at block 1504, a merchant can download a free application onto their mobile devices, which will read bar code or QR code to validate the one time use coupon. In case the bar code or QR code printed on paper is unreadable, the merchant can also manually enter the unique coupon identification number into the smartphone application to validate the one time use coupon. When the merchant scans the bar code or QR code of the one time use coupon, it connects automatically to the CVE to verify if the said coupon is valid, unexpired, and/or unused. Upon installing the mobile application, the merchant will be required to sign into the application to start validating the one time use coupon.

In the case of validating the one time use coupon with internet connected computer at block 1505, the merchant will be given a website link within the Merchant Account of the CSP, which allows the merchant to enter the unique coupon identification number to validate the said coupon.

In the case when internet connection is not available and the merchant wishes to redeem the coupon in real time, the merchant can use the APSC to validate the one time use coupon by calling CSP's APSC number, and transferring the received coupon information to the APSC by inputting the coupon identification number at block 1506. The CVE then checks out the said coupon information on the APSC, and informs the merchant whether or not the coupon is valid in decision block 1508.

For the cases that the merchant has no internet connected device and wishes not to check the validity of the coupon in real time at block 1507, the merchant has two options to redeem the coupons. First option is to collect the physical printed one time use coupon at block 1513 and validate the said coupon at another location where a device with internet connection is available at block 1514. In such case, the terms of the coupon offering must include the content of “bring printed coupon to store” which is part of the Red Terms. The second option is to use iPod Touch Application at block 1515. The merchant can scan the bar code or QR code with an iPod Touch Application that is not connected to the internet, which will store the one time use coupon information within the mobile application, until the device is synced with an internet connection. Once the iPod Touch device gets synced with an internet connection, the scanned one time use coupons get validated automatically. In the case that the merchant scanned an invalid code, it will display a warning message regarding the invalid code scanned. Because these two methods cannot check the coupon validity in real time, it is not recommended, but it should work without a problem for small businesses that has less foot traffic.

Coupon Redemption Problem—Refund Terms

If a consumer wants to refund the purchased one time use coupon, which the consumer has previously purchased, the CSP will provide the consumer with the refund of the coupon purchase.

The following return policy will be enforced for unused coupon.
a) Refund all purchased one time use coupons, except for the special coupons from AMT's, within 31 days—the CSP will pay out the revenue of the coupon sales, minus the commission, and send the payment along with a report to the merchants at the end of every month, but only after minimum of 32 days have passed since the coupon was purchased by a consumer. By such method, the consumer gets chance to refund the coupon within 31 days of purchase, while the CSP is not responsible for any associated losses through refunding the one time use coupons purchased.
b) Exchange coupons from 32 days to 1 year—consumers can exchange the one time use coupon with another one time use coupon from any merchants, at the website of the CSP within the period of time from 32 days to 1 year after the purchase of the coupon, as long as the value of the coupon purchased are equal or less in value. The commission paid to the merchant will be charged back to the CSP which already has the merchant's credit card number or bank card number.
c) Any expired coupon will not be available for a refund, unless required by the State law where the one time use coupon was sold. Consumers will be notified a week prior to the expiration date except for the coupon offering terms with expiration date of 7 days or less.

The APSC also resolves a coupon problem between merchants and consumers if it arises at the store, before, during, or after shopping. APSC will have an option to connect to a live customer support.

Sharing Profit of Coupon Sales and Market Data

After the sales of the one time use coupons based on the coupon offering terms and conditions by the merchants, merchants will receive the revenue of the coupon sales, minus the commission, from the CSP along with the market data including, but not limited to, the coupon data, customer data, and market data. The commission charged to the merchant can be up to fifty (50) percent of the coupon value.

Since consumers can return and ask for a refund of the one time use coupons which they have purchased within 31 days after the coupon purchase, the CSP will send the revenue of the coupon sales, minus the commission, to the merchant at the end of every month after 32 days after the coupon was sold. However, the payment will only go out to the merchants only if the amount of the shared sales is equal to or more than $15. Otherwise, the CSP will keep the shared profits on behalf of the merchant until it will reach to at least $ 15. However, the merchant can check the statements and data regarding current coupon sales and coupon data via Merchant Account view on the website provided by the CSP at any time.

Each month, merchants will get a physical report of their coupon data, customer data, and market data, though they all are also available on the website of the CSP at any time. The coupon data includes 1) market data comprising of coupon offering information offered by other merchants including competitors of said merchants, wherein said coupon offering information includes types of coupon offerings that are popular, average coupon sales per store per month, and 2) the merchants' own coupon offering sales data comprising of number of coupons sold to consumers in the current month, current year, and total number of redeemed coupons, refunded or exchanged coupons, expired coupons, number of non-redeemed or unused coupons, and/or average days that the consumers used coupons after purchase. The merchants' own coupon data may be sorted by coupon type, gender and/or age of the consumers, and the location of the consumers in order for merchant to learn better of their own customers. The consumer data includes location of each of said customers where each of one time use coupons was purchased from, number of coupons purchased per customer, what types of coupons were popular among said customers from the coupons offered by the said merchant. The consumer data can be sorted by gender, age, and/or location of the consumers. The market data includes, but not limited to, the number of the merchants' competitors doing the same or similar businesses within a certain distance range, their coupon offerings, their length of time in business, their marketing budgets, employee numbers, store sizes, goods and services sold, price lists, approximate annual sales, approximate value of inventories, and/or approximate daily foot traffic, which are collected by a various number merchants during merchant registration questionnaire process.

These are priceless data that local merchants cannot usually have access to or afford financially, but provided by the CSP for free of charge upon merchant registering and offering coupon offerings. By creating a merchant-benefit-focused coupon distribution marketing system, CSP is able to build a large merchant network, or number of merchants signed up for the coupon distribution service.

Benefits from the Present Invention

The present invention provides merchants with the benefits as follow:
(a) merchants get paid to participate in marketing promotions by selling one time use coupons, instead of paying to distribute the coupons; the first get-paid-to-participate-marketing promotions;
(b) merchants get guaranteed customers because those who purchase the one time coupons will likely to come and visit the merchant;
(c) merchants obtain their own customer data including, but not limited to, whether their customers are local or tourist, whether customers are frequent visitors or not, how often customers buy their coupon offerings, how early customers buy the coupons before actually visiting their store, customers' age, ethnicity, and/or gender of customers, all for free of charge;
(d) the CSP creates an online merchant profile webpage for all small local businesses for free of charge, including the merchants that cannot afford to create their own webpage, which can includes menus, prices, sales point, pictures, business information, and the benefits of coming to the merchants' stores; and
(e) merchants get a full control of marketing, not just the coupon offerings by managing the terms and prices of the coupons, but also other business promotional methods by managing their online homepage and social network websites, including the business information and the customer communication.

The present invention provides consumers with the benefits as follow:
(a) consumers get discounts at local merchants, either as a new visitor or a frequent visitor; and
(b) consumers get chance to find out what businesses are around the town. It is often that merchant do not reach the consumers because they are hidden around the corner, and/or consumers do not know about the merchants and the benefits of visiting their business locations because consumers are often afraid to try new businesses.

The present invention provides the CSP with the benefits as follow:
(a) the CSP gets paid to sell coupons;
(b) the CSP can gather local market data, including but not limited to, actual foot traffic information of the consumers to businesses, categorized into industries, genders, ethnicity, locations, and/or business sizes; and
(c) the CSP can generate foot traffic and invigorate local small businesses, which are losing grounds from the giant national retailers, of which uses heavily in marketing costs.

What is claimed is:

1. a system for a merchant-benefits-focused electronic coupon distribution business, which provides a website for merchants to upload and manage their coupon offerings by themselves for free, and without intervention from a provider of said system, and sell one time use coupons to consumers based on the terms and conditions of coupon offerings created by said merchants, and for consumers, receive said one time use coupons with unique coupon numbers upon searching through said consumers' desired local markets, choose said coupon offerings said consumer desires, make a payment to said merchant through the said system, and have access to discounts at local merchants' business locations, comprising:
a) a merchant database providing merchants with a graphical user interface on said system's website as merchant account, retrieving merchants' information including said merchants' financial and business information, while said merchants registers for a merchant account;
b) a merchant ID/client table which sorts and stores the said merchant information from said merchant database, coupon offering information from a coupon database, and one time use coupon information from a coupon order database, which includes, but not limited to said merchant business information, consumer spending and foot traffic patterns, terms, prices and status of each of said one time use coupons purchased by said consumers as well as one time use coupon sales information, and providing back said merchants with reports and their one time use coupons sales revenue minus sales commission, wherein said sales commission is not more than a half of said merchants' one time use coupons sales revenue;
c) a merchant webpage server engine running said website by retrieving said merchants and merchants' coupon offering information through said merchant ID/client table, by providing said merchants with their profile webpage and by displaying said merchants and merchants' coupon offering information on said merchant profile webpage for consumers to search, review and purchase said one time use coupons with unique coupon number, which the terms and conditions of said one time use coupons are based on said merchants' coupon offerings;
d) said coupon database providing said merchants with coupon creation guidelines including an available list of said coupon offering terms and conditions, a range of coupon price which said merchants can select, and also storing and maintaining said coupon offering information created by said merchants under said coupon creation guidelines, which includes selected terms and conditions and offered expiration dates; under said coupon creation guidelines, expiration dates does not specify a specific date, however, a length of days in which said merchants choose, in which the expiration date of a purchased one time use coupon starts from the date when said consumer purchases a one time use coupon from said merchants with said coupon offerings and expires after the specified length of days in which said merchant has chosen,
e) said coupon order database including information of said one time use coupons which have been purchased by said consumers based on said terms and conditions created by said merchants in said coupon offerings, which includes unique coupon numbers, purchase and expiration dates, whether used and redeemed, or unused and not redeemed, exchanged, refunded, and which expired, wherein said coupon order database is connected to a consumer ID/client table and said merchant ID/client table to connect information between consumers to merchants;
f) a coupon generator engine retrieving available coupon offering terms and information from said coupon database to verify each of said coupon offerings, and create a unique coupon identification number for each of said coupon offerings purchased from consumers, which said coupon generator engine creates a one time use coupon with unique coupon number generated and gets stored in said coupon order database when consumers purchase said coupon offerings;
g) a coupon validation engine receiving coupon information of said one time use coupons from said merchants upon redemption of said one time use coupons which said consumers purchased, and then checks through said coupon order database to see if each of said one time use coupons is valid, in order to validate said one time use coupon to give proper discount to said consumers and collect consumer data of said merchants' consumers;
h) a automated phone service center which is integrated within said coupon validation engine, and resolves problems between said merchants and said consumers related to said coupon offerings and said one time use coupons of said merchants selling and said consumers purchasing, in a case problems arises at the store between said merchants and said consumers, before, during or after shopping at said store; said automated phone service center also works for said merchants to redeem said one time use coupons via automated service by calling designated service phone number of said system provider;
i) a market database which includes integration of information of said merchant database, said coupon database, and said consumer database through consumer ID/client table, and manual information inputted by said system provider including U.S. Census Data, almanac data, and/or other free or paid government data or statistics;
j) a market database analysis engine providing said merchants with local market data by using the information collected and analyzed in said market database, said merchant database, said coupon database, said consumer database, and also providing said merchants with data, reports, and advanced marketing options for said merchants;
k) a consumer database providing consumers with user interfaces including a main webpage through which consumers can search merchants and coupon offerings, and access to consumer accounts to manage purchased said one time used coupons by retrieving consumer information of consumers while said consumers register for said consumer account; and
l) a consumer ID/client table sorting said consumer information from said consumer database and said coupon order database and information of said one time use coupons purchased by said consumers from said coupon order database.

2. The system in claim 1, wherein creating each of said coupon offerings terms and conditions using a list of coupon terms provided by said system provider, said merchants are requested, but not required, to follow said coupon creation guidelines stored in said coupon database created by said system provider, said list of coupon terms for creating said coupon offerings to sell to consumers are marked in one of three (3) different colors which are red, green, and yellow, where red color coupon terms indicate a not-recommended terms for said merchants, which consumers should watch out for; green color coupon terms indicate a recommended terms for said merchants, which also benefits said consumers, and; a yellow color coupon term indicates somewhere in between said red color coupon terms and said green color coupon terms, which includes normal coupon terms.

3. The system in claim 1, wherein said range of coupon offering price for sale to said consumers is given to said merchants can be selected from $1 to $10, of which a revenue of one time use coupons sales is paid to said merchant, minus said sales commission, wherein said sales commission is not more than a half of said one time uses coupons sales revenue, to provide a get-paid-to-participate coupon distribution marketing promotions for said merchants.

4. The system in claim 1, wherein said coupon database limits each of said merchants to create no more than four (4) types of coupon offerings for business of each of said merchants at any given time, of which said coupon offerings can be created, revised or deleted at any time in the said merchant account view.

5. The system in claim 1, wherein said advanced marketing options, which is used to increase communication between merchants and consumers via email, a website of said system provider, or both, thus increasing said merchants' visibility to said consumer, upon paid to the said system provider by said merchants in the form of time or capital to participate, comprises:
a) a featured list tool provided to said merchants with an option to promote said merchants' coupon offerings as featured coupons on featured list having a special color tone distinguished from non-featured coupon offerings, wherein said merchants are required to pay a fee to said system provider and to give said consumers at least 25% discount to said merchants' goods and services in order for said merchants to utilize said feature list tool, wherein said merchants are allowed to choose feature period, regions, and said coupon offerings for advertising, and wherein featured list is only shown to local consumers among all consumers, based on the zip code inputted by said consumers on said main webpage, which the said featured list increases the awareness of said merchants' business and coupon offerings to said local consumers;
b) a hot list tool provided to the merchants, of which said system provider provides said merchants with requirements on how to feature said merchants' coupon offerings on hot list, and with recommendations on how to increase chances of listing said merchants' coupon offerings on said hot list, wherein said hot list is a list of coupon offerings which have been very popular among the local consumers compared to other coupon offerings in the same local region, and said hot list is only shown to said local consumers among all consumers, based on the zip code inputted by said consumers on said main coupon search webpage, wherein a service of hot list tool is free to all of merchants although may require time investment to find a right coupon offering terms and conditions and work with said system provider, and wherein said hot list comprises a daily hot list, a weekly hot list, and a monthly hot list;
c) a newsletter tool provided to merchants with an option to inform consumers of local businesses and special offers from said merchants by sending newsletter via email to only consumers who want to receive said newsletter from said merchants and/or from said merchants which said consumers have purchased one time use coupons previously, providing said merchants with an option to select a particular group of consumers with number, age, sex, and region, to whom said merchants want to send said newsletter to, and providing base formats and frames of newsletter to said merchants so that said merchants can choose one from said base formats and frames, wherein said merchants are required to pay fee to utilized said newsletter tool and to submit a writing for said newsletter and a date or dates when said newsletter is to be sent;
d) a local advertisement tool provided to merchants with an option to promote said merchants' business by sending out paid one time use coupons to specific categories of consumers via email and/or by U.S. Postal Mail to selected particular group of said consumers chosen by number, age, sex, and region to whom designated by said merchants via U.S. Postal Mail, allowing targeted marketing service on an offline format;
e) a daily deal offer tool provided to merchants with an option to offer special deals to local consumers, wherein said merchants is required to pay fee and to offer each of special deals over fifty percent (50%) discount of services and goods;
f) a daily coupon offer tool provided to the merchants with an option to promote coupon offerings that carry the discount of over 50%, wherein said merchants are required to sell said coupons for less than $5; and
g) a weekly special tool provided to merchants with an option to offer a special sale coupon offerings when said merchants need either to boost temporary sales, get new customers, lowering inventories, and/or to clear out old non-moving inventories, products or goods of said merchants.

6. A method for a merchant-benefits-focused electronic coupon distribution business which provides a website by a provider of said system for merchants to upload and manage their coupon offerings by themselves for free and without any intervention from said system and sell said one time use coupons based on said coupon offerings with terms and conditions created by the said merchant to consumers, and for consumers to buy said one time use coupons which said merchants uploaded upon searching through said consumers' desired local markets, comprising:
a) providing a graphical user interface as a main webpage that allows consumers to use in the process of searching coupon offerings and merchants to allow sell one time use coupons with the same terms and conditions set in said coupon offerings by said merchants who created;
b) providing consumer account to consumers in which said consumers register for said consumer account, input said consumers' basic and optional personal information into said consumer account, search desired markets, merchants, and coupon offerings by inputting search terms or by browsing through map application, and manage said consumers purchased, either used or unused one time use coupons and print said one time use coupons, wherein said consumer account includes personal information management tab, available coupon tab, used/expired coupon tab, and buy coupon tab;
c) providing merchant account to merchants in which said merchants register for said merchant account, input said merchants' financial account information and said merchants' basic and advanced business information into said merchant account, inputs said merchant's coupon offerings terms and conditions and prices to create up to four (4) coupon offerings per merchant per location, manage and control said merchants' financial and business information as well as have options to link to said merchants' own social network accounts and websites, wherein said merchant account includes coupon management tab, business information tab, advanced marketing tools tab, and market data analysis tools tab;
d) providing merchants who have registered for merchant accounts, with a merchant profile webpage which allows said merchants to look at said merchants' financial account and business information as well as said merchants' coupon offering information;
e) providing merchants with coupon creation guidelines including a list of coupon terms which said merchants can select for coupon offerings and a range of coupon price which said merchants can fix prices for said coupon offerings for sale, by themselves without any intervention from said system provider, and posting said coupon offerings on said system provider's website;
f) generating one time use coupons purchased by consumers, under the same terms and conditions listed by said merchants in said coupon offerings, wherein each of said one time use coupons includes its own unique identification number, barcode/QR code, said merchant's name, address, phone number and website if any, main coupon term, optional coupon terms, coupon purchase date, and coupon xpiration date;
g) checking validity of each of said one time use coupons through said system's coupon validation engine of said system when consumers who have purchased said one time use coupons from said merchant's coupon offerings, and redeem said one time use coupons at said merchants' business locations, and said merchants check each said one time use coupon with automated phone service center, or an electronic device with a proper software or application, or on online;
h) providing said merchants with said merchant's coupons sales revenue, deducting sales commission, wherein said sales commission is not more than a half of said merchants' coupon sales revenue; and
i) providing said merchants with advanced marketing options through said advanced marketing tools tab of said merchant account, as well as providing a report with coupon data, and customer data, market data including merchant data, through said market data analysis tools tab of said merchant account, wherein said market data provides local data and nationwide data related to said merchants' business and industry, wherein said merchant can categorize industries and regions for market data, and wherein said market data is provided to said merchants in either narrative form, chart form, and/or graphic form.

7. The method in claim 6, further comprising:
a) requiring said consumers to input said consumers' user name (ID), password as well as said consumers' basic personal information including said consumers' names and email addresses in order for said consumers to register for said consumer accounts;
b) recommending said consumers to input an optional personal information of said consumers including age, gender, mailing address, mobile phone number, bank account, and debit or credit card on said consumer accounts;
c) providing said consumers with a credit ranging from $1 to $3 to spend on said consumers' one time use coupon purchases if said consumers add information of their age, gender, and mailing address;
d) providing said consumers with another credit ranging from $1 to $3 to spend on said consumers' one time use coupon purchases if said consumers further add information of their mobile phone number and confirm via short message service;
e) providing said consumers with another credit ranging from $1 to $3 to spend on said consumers' one time use coupon purchases if said consumers further add information of bank account, credit card, or debit card.

8. The method in claim 6, further comprising;
a) requiring said merchants to input said merchants' user name (ID), password, and financial account information including bank account, and/or debit or credit card account information when said merchants register for said merchant accounts, not only for assurance that said merchants are legitimate, owns the business which offers coupon offerings, and not trying to create a fraudulent business information and coupon offerings to steal money from consumers, but also for a remittance of said merchants' coupon sales revenue minus said sales commission through said financial information;
b) checking the availability of funds in said inputted financial account;
c) requiring said merchants to input said merchants' other financial account information in a case if said funds are not available in said merchants' financial information inputted;
d) requiring said merchants to input said merchants' basic business information including business name, address, contact person information, headquarter office address if any, phone number, social network link, type of business, business descriptions, products and services offered, homepage web address, and price list;
e) verifying the existence of the business automatically with the inputted information, manually by said system provider, or, both;
f) requiring said merchants to input said merchants' advanced business information, except optional business information including business history, building type, approximate age of the building, last time the store was renovated, business square footage, number of employees, languages spoken, availability of computer and/or internet availability in merchants' business locations, ownership of smartphone, average customer wait time, and average customer visit length of time;
g) recommending said merchants to input said optional business information including approximate daily foot traffic, approximate annual sales, approximate value of business inventory, approximate physical size of business, and certificates/awards/media received, which will be analyzed in order to estimate local market information around said merchants' business; and
h) providing only said merchants who completely provide said optional business, with permission to access other merchants' optional business information, and
i) generating and creating automatically, via computer bots, social network accounts for said merchants using said merchants inputted information, if said merchants do not own any of said social network accounts and also said merchants wishes and request to create said social network accounts,
wherein all of said basic, advanced, and optional business information provided by said merchants, are used to create and share market data for said registered merchants.

9. The method in claim 8, wherein said advanced business information and said optional business information are asked with multiple choice questions, or only in ranges formats, not in exact number value or number, in order to protect privacy and share limited information to further invigorate merchants to give more information.

10. The method in claim 6, further comprising:
a) providing said merchants with guidelines on coupon offering terms of said list of coupon terms marked in one of three (3) different colors which are red, green, and yellow, where red color coupon terms indicate a not-recommended terms for said merchants, which consumers should also watch out for, which may include limited redemption hours; green color coupon terms indicate a recommended terms for said merchants, which also benefits said consumers, which may include no minimum purchases, and; a yellow color coupon term indicates somewhere in between said red color coupon terms and said green color coupon terms, which includes normal coupon terms, which may include expiration dates, wherein each of said red color coupon offering terms, said green color coupon offering terms, and yellow color coupon offering terms also are categorized in two types, main coupon term, which includes expiration dates, redemption locations, and optional coupon term which includes, limited redemption hours, minimum purchases requirements; and
b) requiring said merchants to choose minimum of one main coupon term and one or more of said optional coupon terms when said merchants create their own coupon offerings.

11. The method in claim 6, wherein said range of coupon price for coupon offerings is given to said merchants from $1 to $10.

12. The method in claim 6, further comprising:
limiting each of said merchants to create no more than four (4) types of coupons for business of each said merchant.

13. The method in claim 6, wherein said unique coupon identification number of each said one time use coupon comprises merchant number, customer number, and coupon extension number, which created only once per coupon purchased by per customer per time, and valid to be redeemed at merchants' location until used, expired, refunded, and/or exchanged.

14. The method in claim 6, wherein said advanced marketing options, which is used to increase communication between merchants and consumers via email, a website of said system provider, or both, thus increasing merchants' visibility to the said consumer, upon paid to the said system provider by the merchants in the form of time or capital to participate, comprises:
a) a featured list tool provided to said merchants with an option to promote said merchants' coupon offerings as featured coupons on featured list having a special color tone distinguished from non-featured coupon offerings, wherein said merchants are required to pay a fee to said system and to give said consumers at least 25% discount to said merchants' goods and services in order for said merchants to utilize said feature list tool, wherein said merchants are allowed to choose feature period, regions, and coupon offerings for advertising, and wherein featured list is only shown to local consumers among all consumers, based on the zip code inputted by the said consumers on said main coupon search webpage, which said featured list increases the awareness of said merchants' business and coupon offerings to said local consumers;
b) a hot list tool provided to merchants, of which said system provider provides the said merchants with requirements on how to feature said merchants' coupon offerings on hot list, and with recommendations on how to increase chances of listing said merchants' coupon offerings on said hot list, wherein said hot list is a list of coupon offerings which have been very popular among local consumers compared to other coupon offerings in the same local region, and said hot list is only shown to said local consumers among all consumers, based on the zip code inputted by said consumers on said main coupon search webpage, wherein a service of hot list tool is free to all of merchants, although may require time investment to find the right coupon offering terms and conditions and work with said system provider, and wherein said hot list comprises a daily hot list, a weekly hot list, and a monthly hot list;
c) a newsletter tool provided to merchants with an option to inform consumers of local businesses and special offers from said merchants by sending newsletter via email to only said consumers who want to receive said newsletter from said merchants and/or from said merchants which said consumers have purchased one time use coupons previously, providing said merchants with an option to select a particular group of consumers with number, age, sex, and region, to whom said merchants want to send said newsletter to, and providing base formats and frames of newsletter to said merchants so that said merchants can choose one from said base formats and frames, wherein said merchants are required to pay fee to utilized said newsletter tool and to submit a writing for said newsletter and a date or dates when said newsletter is to be sent;
d) a local advertisement tool provided to merchants with an option to promote said merchants' business by sending out paid one time use coupons to specific categories of consumers via email or by U.S. Postal Mail to selected particular group of said consumers chosen by number, age, sex, and region to whom designated by the said merchants via U.S. Postal Mail, allowing targeted marketing service on an offline format;
e) a daily deal offer tool provided to merchants with an option to offer special deals to local consumers, wherein said merchants is required to pay fee and to offer each of special deals over fifty percent (50%) discount of services and goods;
f) a daily coupon offer tool provided to the merchants with an option to promote coupon offerings that carry the discount of over 50%, wherein said merchants are required to sell said coupons for less than $5; and
g) a weekly special tool provided to merchants with an option to offer a special sale coupon offerings when said merchants need either to boost temporary sales, get new customers, lowering inventories, and/or to clear out old non-moving inventories, products or goods of said merchants.

15. The method in claim 6, wherein said coupon data comprising:
a) market coupon offering data which are offered by other merchants including competitors of said merchants, wherein coupon information includes which types of coupon offerings are popular, average coupon sales per store per month; and
b) said merchants' own coupon data comprising number of one time use coupons sold to consumers in current month, current year, and number of redeemed coupons, refunded and exchanged coupons, expired coupons, purchased by non-redeemed or unused coupons, and average days that said consumer used one time use coupons after purchase, wherein said merchants' own coupon data can be sorted by coupon type, gender and age of said consumers, and location of said merchants.

16. The method in claim 6, wherein said consumer data comprises information about said merchants' customers, including number of coupons bought by each of said customers, location of each of said customers where each one time coupons was purchased from, what types of coupons were popular among said customers, wherein said consumer data can be sorted by gender, age, and location of said consumers, providing merchants with reports and information on their number of loyal consumers, number of local consumers, number of one time visiting consumers, and/or other consumer patterns.

17. The method in claim 6, wherein said market data comprises business information about other merchants including beneficiaries and competitors of said merchants in aggregated, generalized, and in range forms, wherein said market data includes number of said competitors doing the same or similar business within a certain distance range, said competitors' type of coupon offerings, said competitors' length of time in business, said competitors' marketing budgets, said competitors' employee number, said competitors' store size, said competitors' goods and services offered, said competitors' approximate annual sales, said competitors' approximate value of inventory, and said competitors' approximate daily foot traffic.

18. The method in claim 6, further comprising:
providing said consumers with refund and exchange policy of coupons which has been purchased, unused and not redeemed, and did not expire.
